(19) United States
(12) Patent Application Publication
(10) Pub. No.: US 2009/0269510 A1
(43) Pub. Date: Oct. 29, 2009

(54) PRINTED ELECTRONICS BY METAL PLATING THROUGH UV LIGHT

(76) Inventors: Daniel Lieberman, San Diego, CA (US); Peter W. de Oliveira, Saarbrucken (DE); Karsten Moh, Saarbrucken (DE); Sarah Schumacher, Saarbrucken (DE); Michael Veith, Ingbert (DE)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/109,740

(22) Filed: Apr. 25, 2008

(51) Int. Cl. B05D 3/06; B05D 5/12; B05C 9/14

(52) U.S. Cl. 427/555; 427/126.1; 427/553; 427/554; 118/620

(57) ABSTRACT

Methods and systems for applying printed electronics to various substrates are provided. In specific embodiments methods and systems for providing a highly reflective silver coating to a substrate are provided. Such methods include use of a photocatalytic material to initiate the reduction of a silver complex applied to the substrate to provide the highly reflective silver coating. The silver coating may conduct electricity.

### FIELD OF THE INVENTION

The present invention is directed to methods and systems for applying printed electronics to various substrates and articles having printed electronics thereon. More specifically, the present invention is directed to methods and systems for applying a metal coating to a substrate.

### BACKGROUND OF THE INVENTION

The application of metal to a substrate has many applications. In some applications such metal coated materials may have use in electronics or otherwise as a conductor of electricity. Other applications may utilize the coated surfaces for display or visual purposes, such as holograms or the like.

### SUMMARY OF THE INVENTION

The present invention provides a method comprising the steps of: providing a substrate; applying an initiator to the substrate; applying a metal to the substrate; and reducing the metal, wherein the reducing results in a metal coating on the substrate that is conductive and highly reflective. In some embodiments the substrate comprises PET foil or polyimide foil. In other embodiments the substrate comprises a hologram (surface reliefs). In certain embodiments the applying an initiator step comprises coating the substrate with a solution comprising TiO₂. In yet other embodiments the wherein the applying a metal to the substrate step occurs prior to the reducing the metal step. In various embodiments the reducing the metal step comprises application of visible light, UV light or laser light to the metal. In other embodiments the applying a metal step comprises application of a metal complex. In some such embodiments the metal complex comprises a metal and a complexing agent. In further embodiments the metal is silver. In some embodiments the complexing agent is TRIS, 3-Ap, 2-Ab or a mixture of 3-Ap and 2-Ab. In other embodiments the metal is copper, gold, nickel, zinc, aluminum, titanium, chromium, manganese, tungsten, platinum or palladium. In some embodiments the metal is an alloy comprising one or more of silver, copper, gold, nickel, zinc, aluminum, titanium, chromium, manganese, tungsten, platinum or palladium. Such alloys may include, without limitation, steel, brass, bronze and duralumin.

The present invention also provides a method comprising the steps of: providing a substrate coated with a TiO₂ solution; applying a metal complex to the substrate; and applying visible, laser, or UV light to the substrate, wherein the applying visible, laser, or UV light results in a metal coating on the substrate that is highly reflective. In some embodiments the substrate comprises PET foil or polyamide foil. In certain embodiments the substrate comprises a hologram. In some embodiments the metal coating on the substrate is conductive. In other embodiments the metal complex comprises a metal and a complexing agent. In some such embodiments the metal is silver. In some such embodiments the complexing agent comprises TRIS, 3-Ap, 2-Ab or a mixture of 3-Ap and 2-Ab. In other embodiments the metal is copper, gold, nickel, zinc, aluminum, titanium, chromium, manganese, tungsten, platinum or palladium. In further embodiments the metal is an alloy comprising one or more of silver, copper, gold, nickel, zinc, aluminum, titanium, chromium, manganese, tungsten, platinum or palladium. Such alloys may include, but are not limited to, steel, brass, bronze and duralumin. In some embodiments the TiO₂ solution comprises an electron transferring surfactant such as modified anatase nanoparticles. In other embodiments the TiO₂ solution comprises a 1 wt % TiO₂ solution in a solution of H₂0/EtOH. In yet other embodiments the metal complex is made by a process comprising the steps of: adding AgNO₃ to a solution of H₂0/EtOH to form a metal solution; and adding the metal solution to a solution of H₂0/EtOH and TRIS.

The present invention also provides a method comprising the steps of: providing a substrate coated with a TiO₂ solution; applying a metal complex to the substrate; and selectively applying visible, laser, or UV light to the substrate, wherein the selectively applying visible, laser, or UV light results in a metal coating on the substrate that is highly reflective only on the selected portions of the substrate. In some embodiments the selectively applying step comprises placement of an element that has portions that permit substantial passage of visible, laser, or UV light, and portions that do not permit substantial passage of visible, laser, or UV light. In some embodiments the selectively applying step comprises directing visible, laser, or UV light only on the selected portions of the substrate. In some embodiments the metal complex comprises a complexing agent and a metal. In some embodiments the metal is silver In other embodiments the metal is copper, gold, nickel, zinc, aluminum, titanium, chromium, manganese, tungsten, platinum or palladium. In further embodiments the metal is an alloy comprising one or more of silver, copper, gold, nickel, zinc, aluminum, titanium, chromium, manganese, tungsten, platinum or palladium. Suitable alloys may include steel, brass, bronze and duralumin.

The present invention further provides a system comprising, a substrate coating applicator configured to apply a coating to a substrate; a heating element configured to apply heat to the substrate; a metal complex applicator configured to apply a metal complex to the substrate; and a light source configured to provide light comprising one or more of UV light and laser light. In some embodiments the coating is a solution of TiO₂. In other embodiments the metal complex comprises silver and one or more of TRIS, 3-Ap and 2-Ab In yet other embodiments the light source is configured to provide light sufficient to form a metal coating on the substrate. In some embodiments the metal coating is highly reflective and conductive.

### BRIEF DESCRIPTION OF THE DRAWINGS

Embodiments of the present invention will now be described, by way of example only, with reference to the following drawings:

FIG. 1 illustrates an elastic band frame having an edge length of about 4 cm, as may be used in embodiments of the present invention.

FIG. 2 illustrates a polyimide foil with high reflective film (showing a reflection of a camera) as may be used in embodiments of the present invention.

FIG. 3 illustrates an elastic band frame having an edge length of about 15 cm, as may be used in embodiments of the present invention.

FIG. 4 illustrates an aluminum mask having 10 cm long blanked out lines that are from 1 mm to 6 mm in width, as may be used in embodiments of the present invention.

FIG. 5 illustrates a silver structure on polyimide foil as may be used in embodiments of the present invention.

FIG. 6 illustrates a silver structure on polyethylene terephthalate foil as may be used in embodiments of the present invention.

FIG. 7 illustrates, via a light optical microscope, portions of a PET foil substrate having a silver complex applied as in an embodiment of the present invention.

FIGS. 8a-d are photographs of silver coatings made in accordance with an embodiment of the present invention that uses a substrate coated with titania and photochemical reduction by laser.

FIG. 9 illustrates an embodiment of a system of the present invention.

FIGS. 10a-c are graphs illustrating the spectral characteristics of light sources used in some embodiments of the present invention. The graphs have spectral irradiation power on the Y axis and wavelength on the X axis.

FIGS. 11a-c are photographs of silver coatings on holographic foils made in accordance with an embodiment of the present invention that uses NaOH as the reducing agent,

FIGS. 12a-d are photographs of silver coatings on holographic foils made in accordance with an embodiment of the present invention that uses a substrate coated with titania and photochemical reduction.

FIG. 13 is a scanning electron micrograph of a holographic PET foil with silver coating made in accordance with an embodiment of the present invention using NaOH as the reducing agent.

FIG. 14 is a scanning electron micrograph of a PET substrate with silver coating made in accordance with an embodiment of the present invention using NaOH as the initiator.

FIG. 15 is a scanning electron micrograph of a PET substrate with silver coating made in accordance with an embodiment of the present invention using a substrate coated with titania and photochemical reduction by UV light.

FIG. 16 depicts a system of printing mirrored surface reliefs on a substrate using onal printing equipment.

FIGS. 17-19 depict embodiments made in accordance with certain embodiments of the present invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Embodiments of the present invention include systems and methods for creating printed electronics and similar materials. In some embodiments, the methods of the present invention include methods of forming a metal coating on a substrate. In various embodiments, the methods also include the steps of preparing the substrate and treating the metallic complex coated substrate and forming a highly reflective and/or conductive metallic coating. In some embodiments systems of the present invention include providing various elements for creating printed electronics and similar materials. The systems of the present invention include various elements for performing the methods of the present invention.

The following abbreviations are used herein: TEOS: tetraethoxysilane; FTS: (3,3,4,4,5,5,6,6,7,7,8,8,8-tridecafluorooctyl)-triethoxysilane; GPTS: (3-glycidyloxypropyl) trimethoxysilane; HDTMS: hexadecyltrimethoxysilane.

Substrates

The substrate may be composed of any material suitable for this purpose. Examples of suitable materials are metals or metal alloys, glass, ceramic, including oxide ceramic, glass ceramic, or plastics. It is of course also possible to use substrates which have a surface layer composed of the aforementioned materials. The surface layer may, for example, be a metallization, an enameling, a glass or ceramic layer or a lacquer. Examples of metals or metal alloys are steel, including stainless steel, chromium, copper, titanium, tin, zinc, brass and aluminum. Examples of glass are soda-lime glass, borosilicate glass, lead crystal and silica glass. The glass may be, for example, plate glass, hollow glass such as vessel glass, or laboratory glass. The ceramic may be, for example, ceramic based on the oxides SiO₂, Al₂O₃, ZrO₂ or MgO or the corresponding mixed oxides. Examples of the plastic which, like the metal too, may be present as a film are polyethylene, e.g. HDPE or LDPE, polypropylene, polyisobutylene, polystyrene, polyvinyl chloride, polyvinylidene chloride, polyvinyl butyral, polytetrafluoroethylene, polychlorotrifluoroethylene, polyacrylates, polymethacrylates, such as polymethyl methacrylate, polyamide, polyethylene terephthalate, polycarbonate, regenerated cellulose, cellulose nitrate, cellulose acetate, cellulose triacetate (TAC), cellulose acetate butyrate or rubber hydrochloride. A coated surface may be formed from customary primer paints or lacquers. In preferred embodiments, the substrate is a polyamide foil, a polyethylene terphthalate (PET) foil or a hologram foil.

The substrate is a material that may be coated with a reducing agent and/or initiator. In some embodiments, the substrate is a material that may be coated by a photocatalytic compound. In such embodiments, the substrate comprises a photocatalytic layer. In some embodiments the photocatalytic layer comprises TiO₂ or ZnO. In preferred embodiments, the photocatalytic layer comprises photocatalytically active TiO₂ and a matrix material and the TiO₂ exhibits a concentration gradient in the matrix material such that the TiO₂ is enriched at the surface of the photocatalytic layer.

The substrate may be of any suitable length, width, and thickness. In some embodiments the length of the substrate is from about 1 cm to about 25 cm. In other embodiments the length of the substrate is from about 10 cm to about 20 cm. In some embodiments, the width of the substrate is from about 1 cm to about 25 cm. In other embodiments the width of the substrate is from about 10 cm to about 20 cm. In some embodiments, the thickness of the substrate is from about 25 micrometers to about 250 micrometers. In other embodiments, the thickness of the substrate is from about 25 micrometers to about 100 micrometers.

In some embodiments the substrate is holographic. For example, the holographic substrate may comprise surface reliefs as described in U.S. patent application Ser. No. 11/551,205 filed on Oct. 19, 2006 and entitled “Substrates and Articles Having Selective Printed Surface Reliefs” (the entire contents of which are incorporated herein by reference in their entirety). In some embodiments only a portion of the substrate has surface reliefs. In such embodiments, only the portion of the substrate having surface reliefs is coated with the metal complex. In some embodiments, only the portion of the substrate having surface reliefs has the coated metal complex reduced in a manner that makes the metal complex reflective.

The surface reliefs described herein are micro and nano surface reliefs such as holograms, optically variable devices, diffractions gratings, nano optical color structures, biological and animal structures, and structures that exhibit surface details from about 10 nm to about 3 mm. For example, the surface reliefs may be applied using conventional printing processes such as flexography, intaglio, rotogravure, ink jet printing, digital printing, tampography and other printing processes. According to further embodiments of the invention, the surface reliefs may be applied to various substrates and articles using laser engraving techniques with or without a metal backing or injection molding techniques for producing high refractive index plastics. The surface reliefs described herein may be applied to any suitable article or substrate, either selectively or in a continuous pattern. When the surface reliefs are selectively applied, a portion of the article or substrate does not contain any surface reliefs.

The surface reliefs may comprise inks possessing high and low refractive properties plus a wide variety of other effects including, but not limited to: (1) color shifting effects; (2) thermochromatic effects; (3) dielectric effects; (4) luminescent effects; (5) phosphorescent effects; (6) conductive effects; (7) metallic effects; and (8) combinations thereof. Additionally, the surface reliefs may be printed with any suitable ink and/or lacquer, and then covered with a registered HRISR ink and/or lacquer to provide the desired effects (e.g., color shifting, thermochromatic, etc.). According to further embodiments of the invention, surface reliefs are printed using conventional inks, wherein the entire substrate is flooded with a high and/or low refractive index ink and or lacquer to provide the desired effects (e.g., color shifting, thermochromatic, etc.).

The above-described surface reliefs may be printed in different shades or grades. In addition, the surface reliefs may be printed in register on top of already applied inks and/or lacquers, or may be overprinted with any suitable inks and/or lacquers in register or in a wallpaper pattern. These inks and lacquers obviate the need for already-embossed substrates including films, hot-stamping foils and cold-stamping foils. Such already-embossed substrates are expensive and difficult to integrate with conventional printing at high speeds and proper registration. Moreover, any of the surface reliefs described herein may be created by reverse printing a metallic ink and/or lacquer in order to give the resulting product a metallic look.

Some embodiments provide nano-, micro- and macrostructures that exhibit surface reliefs of more than 5 nanometers to less than 3 millimeters in depth and width are “printed” or cast (cured) in conventional or digital printing equipment with perfect registration to the other printing stations. Such structures may be optical or non-optical in nature. For example, holograms may be printed such that they become reflective, semi-reflective or non-reflective in just one pass through the “printing” station. Some of the advancements described herein are due in part to recent developments in metallic ink technology, gearless technology, sleeve technology, electron beam technology, UV technology, and temperature control technology.

Surface reliefs such as holograms may be cast or embossed in a single pass, or in multiple passes. The surface reliefs may be metallized, semi-metallized or made transparent without the need for prohibitively expensive vacuum-metallizing or sputtering-metallizing equipment. Additionally, the coatings may be selected to possess optical coating properties such as magnetic properties, metallic properties and the ability to change colors. Moreover, the surface reliefs of the invention may be configured to interact with the HRISR and LRISR coatings to create innovative and improved optical effects.

Use of the HRISR and LRISR coatings allow a printer to print surface reliefs such as holography online and in register with conventional printing. Specifically, the coatings of the invention may be applied to an article or substrate using conventional printing equipment including, but not limited to: (1) offset printing; (2) flexographic printing; (3) rotogravure printing; (4) ink jet printing; (5) letterpress printing; (6) digital printing; (7) silk-screen printing; (8) intaglio printing; and (10) litho printing. The surface reliefs may also be produced using laser engraving processes with or without a metal backing material or injection molding processes for producing high refractive index plastics. The HRISR or LRISR coatings preferably are applied and embossed with a surface relief at the same color station. Alternatively, the HRISR or LRISR coatings may be applied in a co responding color station in register to a surface relief that was previously placed at a different color station.

A selected HRISR or LJRISR coating may contain particulate matter such as metallic particles and/or high refractive index particles to make the coating highly reflective. Suitable particulate matter for producing reflective surface reliefs include, but are not limited to: (1) aluminum particles; (2) silver particles; (3) gold particles; (4) cobalt particles; (5) chromium particles; (6) platinum particles; (7) palladium particles; (8) nickel particles; (9) cobalt particles; (10) carbon particles; (11) platelets; (12) flakes; (13) dielectric particles; (14) cholesteric liquid crystal polymer particles; (15) magnetic pigment flakes; (16) holographic glitter particles; (17) aluminum oxides (e.g., AL₂O₃); (18) Ce₂O₃; (19) SnO₂; (20) B₂; (21) O₃; (22) titanium dioxide (TIO₂); (23) iron oxides (e.g., Fe₃O₄ and Fe₂O₃); (24) zirconium oxide (ZrO₂); (25) zinc oxide (ZnO); (26) zinc sulfide (ZnS); (27) bismuth oxychloride; (28) indium oxide (In₂O₃); (29) indium-tin-oxide (ITO); (30) tantalum pentoxide (Ta₂O₅); (31) cenic oxide (CeO2); (32) yttrium oxide (Y₂O₃); (33) europium oxide (Eu₂O₃); (34) hafnium nitride (HfN); (35) hafnium carbide (HfC) (36) hafnium oxide (HfO₂); (37) lanthanum oxide (La₂O₃); (38) magnesium oxide (MgO); (39) neodymium oxide (Nd₂O₃); (40) praseodymium oxide (Pr6O₁₁); (41) samarium oxide (Sm₂O₃); (42) antimony trioxide (Sb₂O₃); (43) silicon carbide (SiC; (44) silicon nitride (Si₃N₄); (45) silicon monoxide (SiO); (46) selenium trioxide (Se₂O₃); (47) tin oxide (SnO₂); (48) tungsten trioxide (WO₃); and (49) combinations thereof.

A selected HRISR or LRISR coating may contain particulate matter adapted to create semi-transparent and metallizing effects. Suitable particulate matter for maintaining the transparency of the coating while keeping surface relief reflective enough in order to be easily seen (even when covered by adhesives, inks, lacquers, and/or laminates) include, but are not limited to: (1) titanium dioxide (TiO₂); (2) iron oxide Fe₂O₃; (3) aluminum oxide (Al₂O₃); (4) Ce₂O₃; (5) tin oxide (SnO₂); (6) boric oxide (B₂O₃); (7) titanium dioxide (TiO₂); (8) zirconium; (9) zinc oxide (ZnO); (10) zinc sulfide (ZnS); (11) bismuth oxychloride; (12) Sb₂O₅; (13) zirconium oxide (ZrO₂); (14) dielectric particles; (15) tungsten oxide (SnWO₄); (16) oxide of bismuth (BiOx); (17) bismuth oxide (Bi₂O₃); (18) titanium oxide (TiO); (19) niobium oxide (Nb₂O₅); (20) carbon; (21) indium oxide (Jn₂O₃); (22) indium-tin-oxide (ITO); (23) tantalum pentoxide (Ta₂O₅); (24) ceric oxide (CeO₂); (25) yttrium oxide (Y₂O₃); (26) europium oxide (Eu₂O₃); (27) Fe₃O₄; (28) hafnium nitride (HN); (29) hafnium carbide (HfC); (30) hafnium oxide (HfO₂); (31) lanthanum oxide (La₂O₃); (32) magnesium oxide (MgO); (33) neodymium oxide (Nd₂O₃); (34) preododymium oxide (Pr₆O₁₁); (35) samarium oxide (Sm₂O₃); (36) antimony trioxide (Sb₂O₃); (37) silicon carbide (SiC); (38) silicon nitride (Si₃N₄); (39) silicon monoxide (SiO); (40) selenium trioxide (Se₂O₃); (41) tungsten trioxide (WO₃); and (42) combinations thereof.

The HRISR and LRISR coatings described herein may also include particulate matter for achieving high transparency. Suitable particulate matter for LRISR coatings for producing the desired high transparency include, but are not limited to: (1) silicon dioxide (SiO₂); (2) aluminum oxide AL₂O₃; (3) magnesium fluoride (MgF₂); (4) aluminum fluoride (AlF₃); (5) cerium fluoride (CeF₃); (6) lanthanum fluoride (LaF3); (7) sodium aluminum fluorides (e.g., Na₃AlF₆ and Na₃Al₃Fl₄); (8) neodymium fluoride (dF₃); (9) samarium fluoride (SmF₃); (10) barium fluoride (BaF₂); (11) calcium fluoride (CaF₂); (12) lithium fluoride (LiF); (13) monomers; (14) polymers; (15) dienes; (16) alkenes; (17) acrylates; (18) perfluoroalkenes; (19) polytetrafluoroethylene; (20) fluorinated ethylene propylene (FEP); and (21) combinations thereof.

In preferred embodiments, the substrate is cleaned prior to application of the metallic complex and/or reducing agent and/or initiator coating. Any suitable materials and/or substances may be used to clean the substrate. In various embodiments, alcohol and/or water are used to clean the substrate using a cloth. In embodiments having a substrate that is a polyamide, PET, or hologram foil, preferably ethanol or propanol and lint-free cloths are used for the cleaning.

Substrate Coatings/Reducing Agents/Initiators

Some embodiments of the present invention include the use one or more reducing agents. A reducing agent is an agent that donates one or more electrons during a reduction reaction. In the context of the present invention a reducing agent is one that is oxidized or donates electrons during the reduction of one or more of the metal atoms in the metallic complex. Preferably, a reducing agent is one that when used under appropriate conditions results in a high quality metallic coating and does not require a prolonged or complicated reaction to form the high quality metallic coating. Any suitable reducing agent may be used. In some embodiments, NaOH and/or KOH may be used as a reducing agent. In other embodiments, NH₃, (N₄)OH, Corona, Hünig-Base, or a sugar may be used as a reducing agent. In some embodiments, visual light, UV light, and/or laser light is the reducing agent. In other embodiments heat is the reducing agent. In some embodiments the reducing agent may be coated onto the substrate. In other embodiments, the reducing agent is added after the metallic complex is applied to the substrate.

Some embodiments of the present invention include the use of an initiator. An initiator is an agent that catalyzes the reduction of the metal in the metallic complex and/or the oxidation of the reducing agent. Preferably, the initiator has a bond gap of about 3.2 electronvolts (eV) or more. In some embodiments a dopant is added to the initiator to give it a bond gap of about 3.2 eV or more. In some embodiments the dopant is a metal. In some embodiments the initiator is a photocatalytic compound. In some embodiments the initiator is ZnO. In preferred embodiments TiO₂ is the photocatalytic compound, but any suitable compound may be used. In some embodiments, the initiator is coated onto the substrate. In other embodiments, the initiator is applied after the metallic complex is added to the substrate. In the preferred embodiments, the initiator is TiO₂ that is surface modified with an electron transferring surfactant and that is coated onto the substrate. Any suitable mixture of TiO₂ and any suitable electron transferring surfactant may be used. In preferred embodiments, the TiO₂ layer comprises surface modified anatase nanoparticles.

In some embodiments, a 1 weight % TiO₂ in a solution consisting of deionized water and ethanol in a ratio of H₂0:EtOH→30:70 wt % is used to create the layer of TiO₂ on the substrate. In other embodiments a 1 weight % TiO₂ in a solution consisting of deionized water and ethanol in a ratio of H₂0:EtOH→20:80 wt % is used.

For the application, the customary processes are used, for example dipping, rolling, roller-dip, flooding, knife coating, flow coating, drawing, spraying, spinning or spreading. The applied dispersion is optionally dried and heat-treated, for instance for hardening or compaction. The heat treatment used for this purpose depends of course upon the substrate. In the case of plastics substrates or plastics surfaces which generally have a barrier layer (see below), it is not possible by their nature to use very high temperatures. For instance, polycarbonate (PC) substrates are heat treated, for example, at about 130° C. for 1 hour. Generally, the heat treatment is carried out, for example, at a temperature of from 100 to 200° C., and, as long as no plastic is present, up to 500° C. or more. The heat treatment is carried out, for example, for from 15 minutes to 2 hours.

The obtained TiO₂ layers may have any suitable thickness. In some embodiments layer thicknesses of from 50 nm to 200 μm are obtained. In preferred embodiments the layer is from 100 nm to 1 μm thick. In further embodiments the layer is from 50 to 700 nm thick. In other embodiments the layer is from 20 to 70 micrometers thick.

By way of example, the TiO₂ may come from an in-house production based on U.S. patent application Ser. No. 11/030,172 entitled “Substrates Comprising A Photocatalytic TiO₂ Layer” filed on Sep. 1, 2005 and incorporated herein by reference in its entirety.

In some embodiments the substrate comprising a photocatalytic layer of TiO₂ is made by a process comprising: a) mixing TiO₂ particles with a surface modifier to form surface-modified TiO₂ particles, b) adding an inorganic matrix-forming material and/or an organically modified inorganic matrix-forming material to the TiO₂ particles of a) to form a dispersion, c) applying the dispersion of b) to the substrate, and d) hardening the applied dispersion to form a photocatalytic layer which has surface-modified TiO₂ particles enriched at the surface thereof.

In one aspect of the process, the surface modifier may comprise at least one hydrophobic group. For example, the at least one hydrophobic group may comprise one or more fluorine atoms and/or a long-chain aliphatic hydrocarbon group and/or an aromatic group. In another aspect of the process, the surface modifier may be selected from hydrolyzable silane compounds, carboxylic acids, carbonyl halides, carboxylic esters, carboxylic anhydrides, oximes, B-dicarbonyl compounds, alcohols, amines, alkyl halides and derivatives thereof.

In yet another aspect of the above process, the TiO₂ particles may comprise TiO₂ particles that have been prepared by i) preparing a mixture which comprises one or more hydrolyzable titanium compounds, water in a substoichiometric amount based on the hydrolyzable groups of the titanium compound(s), and an organic solvent, and ii) treating the mixture of i) at a temperature of at least 60° C. to form a dispersion or a precipitate of TiO₂ particles. Optionally, the solvent may be removed to form a powder of TiO₂ particles. Further optionally, another solvent may be added to these TiO₂ particles. In a further aspect, the process may further comprise an activation of the photocatalytic layer of d) by irradiation. In another aspect of the process, the TiO₂ particles may comprise nanoscale TiO₂ particles, for example, TiO₂ particles having an average particle size of ≦200 nm, e.g., an average particle size of ≦50 nm, or an average particle size of ≦10 nm. In another aspect, the process may comprise a heat treatment and/or an irradiation, and in the case of an irradiation the organically modified inorganic matrix-forming material may have functional groups through which crosslinking is possible.

In some embodiments the substrate also includes a hybrid layer of an organically modified inorganic material disposed between the substrate and the photocatalytic layer. The organic constituents of the organically modified inorganic material have been decomposed photocatalytically at least at the interface to the photocatalytic TiO₂-containing layer to form a purely inorganic barrier layer. In one aspect of this substrate, at least at the interface to the substrate the hybrid layer may consist of an organically modified inorganic material. In another aspect of the substrate, the photocatalytic TiO₂-containing layer may comprise doped TiO₂. The doped TiO₂ may, for example, comprise a metal, a semimetal and/or a nonmetal and/or a compound of a metal, a semimetal and/or a nonmetal. Also, the doped TiO₂ may exhibit photocatalytic activity within a region of the visible light at wavelengths of >380 nm. In yet another aspect, the substrate may comprise an electrically conductive sublayer which is disposed below the photocatalytic layer. In a still further aspect, the photocatalytic layer may comprise a microstructured photocatalytic layer.

In some embodiments, the above substrate is producing by a process comprising: a) applying an organically modified inorganic matrix-forming material to the substrate to form a hybrid layer, b) applying a composition comprising surface-modified TiO₂ particles having organic groups to the hybrid layer of a) to form the photocatalytic layer, the surface-modified TiO₂ particles having been prepared by mixing TiO₂ particles with a surface modifier, and c) photocatalytically decomposing the organic groups of the surface-modified TiO₂ and the organic constituents of the hybrid layer at least in the interface region to the photocatalytic layer to form a purely inorganic barrier layer.

In one aspect of the above process, the surface modifier may comprise at least one hydrophobic group. For example, the hydrophobic group may comprise one or more fluorine atoms and/or a long-chain aliphatic hydrocarbon group and/or an aromatic group. For example, the surface modifier may be selected from hydrolyzable silane compounds, carboxylic acids, carbonyl halides, carboxylic esters, carboxylic anhydrides, oximes, .beta.-dicarbonyl compounds, alcohols, amines, alkyl halides and derivatives thereof In another aspect, the process may further comprise an activation of the photocatalytic layer by irradiation. In yet another aspect of the process, the organically modified inorganic matrix-forming material may comprise a nanocomposite which comprises nanoscale inorganic particles. For example, the nanoscale particles may have a particle size of ≦200 nm. Also, the nanoscale particles may comprise TiO₂ particles, for example, TiO₂ particles having an average particle size of ≦200 nm, e.g., an average particle size of ≦50 nm, or an average particle size of ≦10 nm. In a still further aspect of the process, the organically modified inorganic matrix-forming material may have been formed from an organically modified inorganic hydrolyzate and/or an organically modified inorganic polycondensate of at least one hydrolyzable compound which does not comprise a non-hydrolyzable organic group, and at least one hydrolyzable compound which comprises at least one non-hydrolyzable organic group, not more than 10 mol % of the at least one hydrolyzable compound containing a non-hydrolyzable organic group.

In some embodiments a photocatalytically active TiO₂ powder may be prepared by a process comprising: a) preparing a mixture comprising at least one hydrolyzable titanium compound, water in a substoichiometric amount based on the hydrolyzable groups of the titanium compound, and an organic solvent, b) treating the mixture of a) at a temperature of at least 60° C. to form a dispersion or a precipitate of TiO₂ particles, and c) removing the solvent to form a powder of TiO₂ particles. In one aspect of this process, b) may comprise a hydrothermal treatment and/or a heating under reflux. In another aspect, not more than 0.7 mol of water based on 1 mol of the hydrolyzable groups of the at least one titanium compound may be used in a). In yet another aspect, the mixture of a) may further comprise a dopant.

Some embodiments of the present invention utilize an agglomerate-free, photocatalytically active TiO₂ which has an X-ray-determined volume average particle size of ≦10 nm, and is obtainable by the above process, including the various aspects thereof. The present invention also provides a process for producing a substrate having a photocatalytic layer. This process comprises: a) preparing a mixture which comprises at least one hydrolyzable titanium compound, water in a substoichiometric amount based on the hydrolyzable groups of the titanium compound, and an organic solvent, b) treating the mixture of a) at a temperature of at least 60° C. to form a dispersion or a precipitate of TiO₂ particles, c) optionally, removing the solvent to form a powder of TiO₂ particles and adding a different solvent to form a dispersion of TiO₂ particles, d) applying the dispersion of b) or c) to the substrate and e) heat-treating the applied dispersion to form a photocatalytic layer. In one aspect of this process, b) may comprise a hydrothermal treatment and/or a heating under reflux. In another aspect of the process, not more than 0.7 mol of water based on 1 mol of the hydrolyzable groups of the at least one titanium compound may be used in a). In yet another aspect, the mixture of a) may further comprise a dopant. In some embodiments, the substrate is self-cleaning and/or capable of being cleaned with the aid of irradiation. This substrate comprises any of the substrates set forth above, including the various aspects thereof.

As set forth above, some embodiments utilize a process for producing a substrate having a photocatalytic layer, which process comprises the following steps: a) preparing a mixture comprising at least one hydrolyzable titanium compound, an organic solvent and water in a substoichiometric amount, based on the hydrolyzable groups of the titanium compound, b) treating the resulting mixture at a temperature of at least 60° C. to form a dispersion or a precipitate of TiO₂ particles, c) optionally exchanging the solvent by removing the solvent to form a powder of TiO₂ particles and adding another solvent to form a dispersion of TiO₂ particles, d) applying the dispersion to the substrate and e) heat-treating the applied dispersion to form a photocatalytic layer. In preferred embodiments, in the process for producing TiO₂ particles or for preparing the substrate having a photocatalytic layer, at least one dopant is additionally added in step a) and/or a hydrothermal treatment or heating under reflux is carried out in step b).

In some embodiments, to produce a photocatalytic layer on the substrate, a dispersion comprising TiO₂ particles may be prepared in accordance with the sol-gel process illustrated later. The TiO₂ particles may also precipitate to form a precipitate. Removal of the solvent affords a powder. In the process of the first aspect of the invention, a mixture comprising at least one hydrolyzable titanium compound, an organic solvent and water in a substoichiometric amount based on the hydrolyzable groups of the titanium compound is initially prepared in step a), and the mixture may also optionally comprise at least one metal compound as a dopant

The hydrolyzable titanium compound may in particular be a compound of the formula TiX₄ where the hydrolyzable X groups which may be different or preferably the same may, for example, be hydrogen, halogen (F, Cl, Br or I, in particular Cl and Br), alkoxy (preferably C₁₋₆-alkoxy, in particular C₁₋₄-alkoxy, e.g. methoxy, ethoxy, n-propoxy, isopropoxy, butoxy, isobutoxy, sec-butoxy and tert-butoxy), aryloxy (preferably C₆₋₁₀-aryloxy, e.g. phenoxy), acyloxy (preferably C₁₋₆-acyloxy, e.g. acetoxy or propionyloxy) or alkylcarbonyl (preferably C₂₋₇-alkylcarbonyl, e.g. acetyl). A specific example of a halide is TiCl₄. Preferred hydrolyzable X radicals are alkoxy groups, in particular C₁₋₄-alkoxy. Specific titanates used with preference are Ti(OCH₃)₄, Ti(OC₂H₅)₄ and Ti(n- or iso-OC₃H₇)₄.

The mixture also comprises water in a substoichiometric amount based on the hydrolyzable groups of the titanium compound, i.e. less than one mole of water is present based on 1 mol of hydrolyzable groups in the titanium compound other words, less than 4 mol of water are added based on 1 mol of a hydrolyzable titanium compound having 4 hydrolyzable groups. Preferably not more than 0.7 mol, more preferably not more than 0.6 mol and in particular not more than 0.5 mol or 0.4 mol, and not less than 0.35 mol, preferably not less than 0.30 mol of water, are used based on 1 mol of hydrolyzable groups in the titanium compound.

In a preferred aspect of the preparation of doped particles, the metal compound used for the doping may be any suitable metal compound, for example an oxide, a salt or a complex, for example, a halide, nitrates, sulfate, carboxylate (e.g. acetate) or acetylacetonate. The compound should suitably be soluble in the solvent used for the mixture. Suitable metals include all metals, especially metals selected from groups 5 to 14 of the Periodic Table of the Elements and the lanthanoids and actinoids. The groups are listed here in accordance with the new IUPAC system, as reproduced in Rompp Chemie Lexikon, 9th edition. The metal may be present in the compound in any suitable oxidation state. According to the new IUPAC system, groups 1, 2 and 13 to 18 correspond to the 8 main groups (IA to VIIIA according to CAS), groups 3 to 7 correspond to subgroups 3 to 7 (IIIB to VIIB according CAS), groups 8 to 10 correspond to subgroup 8 (VIII according to CAS) and groups 11 to 12 correspond to subgroups 1 and 2 (Cu and Zn group, IB and IIB according to CAS). Examples of suitable metals for the metal compound include W, Mo, Cr, Zn, Cu, Ag, Au, Sn, In, Fe, Co, Ni, Mn, Ru, V, Nb, Ir, Rh, Os, Pd and Pt. Preference is given to using metal compounds of W(VI), Mo(VI), Cr(III), Zn(II), Cu(II), Au(III), Sn(IV), In(III), Fe(III), Co(II), V(V) and Pt(IV). Very good results are obtained especially using W(VI), Mo(VI), Zn(II), Cu(II), Sn(IV), In(III) and Fe(III). Specific examples of preferred metal compounds include WO₃, MoO₃, FeCl₃, silver acetate, zinc chloride, copper(II) chloride, indium(III) oxide and tin(IV) acetate.

The ratio between the metal compound and the titanium compound also depends upon the metal used and its oxidation state. In general the ratios used are, for example, such that a molar ratio of metal of the metal compound to titanium of the titanium compound (Me/Ti) of from 0.0005:1 to 0.2:1, preferably from 0.001:1 to 0.1:1 and more preferably to 0.005:1 to 0.1:1 results. Instead of metal doping, doping may also be carried out with semimetal or nonmetal elements, for example with carbon, nitrogen, phosphorus, sulfur, boron, arsenic, antimony, selenium, tellurium, chlorine, bromine and/or iodine. For this purpose, the dopants used are either the elements as such or suitable element compounds.

The doped TiO₂ particles have the particular feature that, with suitable selection of the doping element and the process, they may have photocatalytic activity even in the event of excitation with visible light of a wavelength of >380 nm (visible light or daylight photocatalysts).

The solvent used is an organic solvent in which the hydrolyzable titanium compound is preferably soluble. The solvent is also preferably miscible with water. Examples of suitable organic solvents include alcohols, ketones, ethers, amides and mixtures thereof Preference is given to using alcohols, preferably lower aliphatic alcohols (C₁-C₆-alcohols), such as ethanol, 1-propanol, isopropanol, sec-butanol, tert-butanol, isobutyl alcohol, n-butanol and the pentanol isomers, especially 1-pentanol, of which particular preference is given to 1-propanol and 1-pentanol.

The mixture preferably comprises a catalyst for hydrolysis and condensation under sol-gel conditions, especially an acidic condensation catalyst, for example hydrochloric acid, phosphoric acid or formic acid.

The resulting mixture is then treated at a temperature of at least 60° C. to form a dispersion or a precipitate of doped or undoped TiO₂ particles. The heat treatment is preferably carried out hydrothermally or by heating under reflux. Appropriately, a relatively high dilution is employed in the heat treatment, especially when heating under reflux.

The heat treatment is carried out preferably over a period of from 0.5 to 30 hours, preferably from 4 to 24 hours, the duration depending on the temperature and any pressure applied. For example, anatase is obtained by hydrothermal treatment at 200° C. and autogenous pressure after a reaction time of 1 hour in nanoparticulate form in a yield of approx. 35% of the theoretical yield. The heating under reflux is typically carried out over a period of at least 3 hours. The solvents used are preferably alcohols having at least 4, preferably at least 5 carbon atoms, for example n-pentanol, hexanol, heptanol or octanol. However, it is also possible to employ other polar solvents, for example thiols such as n-butyl, amyl, hexyl or heptyl mercaptan.

A hydrothermal treatment refers generally to a heat treatment of an aqueous solution or suspension under elevated pressure, for example at a temperature above the boiling point of the solvent and a pressure above 1 bar. In the present invention, the term “hydrothermal treatment” includes also a heat treatment in a predominantly organic solvent which contains only little water, if any, under elevated pressure. In the hydrothermal treatment, the mixture is heat-treated in a closed vessel or a closed autoclave. The treatment is carried out preferably at a temperature in the range of from 75° C. to 300° C., preferably above 200° C., more preferably from 225 to 275° C., for example at about 250° C. The heating, especially above the boiling point of the solvent, builds up a pressure in the closed vessel or autoclave (autogenous pressure). The resulting pressure may be, for example, above 1 bar, in particular from 50 to 500 bar or more, preferably from 100 to 300 bar, e.g. 200 bar. In general, the hydrothermal treatment is carried out for at least 0.5 hour and preferably up to 7 or 8 hours.

The heat treatment of step b) is carried out until the desired doped or undoped TiO₂ particles have been formed. The dispersion or precipitate may be used for the coating of the substrate directly or after solvent exchange. In order to obtain TiO₂ particles in powder form, the solvent is removed.

The resulting doped or undoped TiO₂ particles of the dispersion, of the precipitate or of the powder are predominantly crystalline and in the anatase form. The crystalline fraction of the resulting doped TiO₂ particles preferably amounts to more than 90%, preferably more than 95% and in particular more than 97%, i.e. the amorphous fraction is in particular below 3%, for example 2%. The average particle size (X-ray-determined volume average) is preferably not more than 20 nm, more preferably not more than 10 nm. In a particularly preferred aspect, particles having an average particle size of from about 2 to 10 nm are obtained. Compared to existing TiO₂ materials, the TiO₂ particles prepared in accordance with the invention exhibit agglomerate-free dispersibility. When the TiO₂ particles are doped, a particularly homogeneous distribution of the doping metals is obtained.

The resulting dispersion may be used as such to coat the substrate. Appropriately, there is a preceding solvent exchange. In this case, preference is given to removing the particles from the solvent in the dispersion obtained in step b). For this purpose, all processes known to those skilled in the art may be used. A centrifugation is particularly suitable. The removed TiO₂ particles are then dried (for example at 40° C. and 10 mbar). In this form, the particles may also be stored viably.

For the application to the substrate, the TiO₂ particles are dispersed again in a solvent. Suitable for this purpose are, for example, the above-listed solvents or water. The solvent used is preferably a water/alcohol mixture and more preferably water alone.

In a preferred aspect, an inorganic or organically modified inorganic matrix-forming material is added to the dispersion obtained after step b) or c). This may in particular be inorganic sols or organically modified inorganic hybrid materials or nanocomposites. Examples thereof are optionally organically modified oxides, hydrolyzates and (poly)condensates of at least one glass- or ceramic-forming element M, in particular an element M from groups 3 to 5 and/or 12 to 15 of the Periodic Table of the Elements, preferably of Si, Al, B, Ge, Pb, Sn, Ti, Zr, V and Zn, in particular those of Si and Al, most preferably Si, or mixtures thereof. Fractions of elements of groups 1 and 2 of the Periodic Table (e.g. Na, K, Ca and Mg) and of groups 5 to 10 of the Periodic Table (e.g. Mn, Cr, Fe and Ni) or lanthanoids may also be present in the oxide, hydrolyzate or (poly)condensate. Polyorganosiloxanes are preferred organically modified inorganic hybrid materials. Particular preference is given to using for this purpose hydrolyzates of glass- or ceramic-forming elements, in particular of silicon. The inorganic or organically modified inorganic matrix-forming material is preferably added in such an amount that the molar ratio of titanium of the titanium compound to glass- or ceramic-forming element M is from 100:0.01 to 0.01:100, preferably from 300:1 to 1:300. Very good results are obtained at a molar ratio Ti/M of from about 10:3 to 1:30. This addition achieves an improvement in the adhesion. When an organically modified inorganic matrix-forming material is used, all or only a portion of the glass- or ceramic-forming elements M present may have one or more organic groups which are non-hydrolyzable groups.

The inorganic or organically modified inorganic matrix-forming materials may be prepared by known processes, for example by flame pyrolysis, plasma processes, gas phase condensation processes, colloid techniques, precipitation processes, sol-gel processes, controlled nucleation and growth processes, MOCVD processes and (micro)emulsion processes. When solvent-free particles are obtained from the process, they are suitably dispersed in a solvent.

The inorganic sols and in particular the organically modified hybrid materials are preferably obtained by the sol-gel process. In the sol-gel process which can also be used for the separate preparation of the particles, hydrolyzable compounds are conventionally hydrolyzed with water, optionally under acidic or basic catalysis, and optionally at least partially condensed. The hydrolysis and/or condensation reactions lead to the formation of compounds or condensates having hydroxyl, oxo groups and/or oxo bridges which serve as precursors. It is possible to use stoichiometric amounts of water, but also smaller or larger amounts. The sol which forms can be adjusted to the viscosity desired for the coating composition by suitable parameters, for example degree of condensation, solvent or pH. Further details of the sol-gel process are described, for example, in C. J. Brinker, G. W. Scherer: “Sol-Gel Science—The Physics and Chemistry of Sol-Gel Processing”, Academic Press, Boston, San Diego, New York, Sydney (1990).

In the preferred sol-gel process, the oxides, hydrolyzates or (poly)condensates are obtained by hydrolysis and/or condensation from hydrolyzable compounds of the above-mentioned glass- or ceramic-forming elements which optionally additionally carry non-hydrolyzable organic substituents to prepare the organically modified inorganic hybrid material.

Inorganic salts are formed in the sol-gel process in particular from hydrolyzable compounds of the general formula MXₙ where M is the above-defined glass- or ceramic-forming element, X is as defined in formula (I) below where two X groups may be replaced by one oxo group, and n corresponds to the valence of the element and is usually 3 or 4. They are preferably hydrolyzable Si compounds, especially of the formula (I) below. Examples of usable hydrolyzable compounds of elements M which are different from Si are Al(OCH₃)₃, Al(OC₂H₅)₃, Al(O-n-C₃H₇)₃, Al(O-i-C₃H₇)₃, Al(O-n-C₄H₉)₃, Al(O-sec-C₄H₉)₃, AlCl(OH)₂, Al(OC₂H₄OC₄H₉)₃, TiCl₄, Ti(OC₂H₅)₄, Ti(O-n-C₃H₇)₄, Ti(O-i-C₃H₇)₄, Ti(OC₄H₉)₄, Ti(2-ethylhexoxy)₄, ZrCl₄, Zr(OC₂H₅)₄, Zr(O-n-C₃H₇)₄, Zr(O-i-C₃H₇)₄, Zr(OC₄H₉)₄, ZrOCl₂, Zr(2-ethylhexoxy)₄, and Zr compounds which have complexing radicals, for example B-diketone and (meth)acryloyl radicals, sodium methoxide, potassium acetate, boric acid, BCl₃, B(OCH₃)₃, B(OC₂H₅)₃, SnCl₄, Sn(OCH₃)₄, Sn(OC₂H₅)₄, VOCl₃ and VO(OCH₃)₃.

The above remarks on the preferred silicon also apply mutatis mutandis to the other elements M. Particular preference is given to obtaining the sol or the organically modified inorganic hybrid material from one or more hydrolyzable and condensable silanes, and at least one silane optionally has a non-hydrolyzable organic radical. Particular preference is given to using one or more silanes having the following general formulae (I) and/or (II):

SiX₄ (I) where the radicals X are the same or different and are hydrolyzable groups or hydroxyl groups.

RₐSiX₍₄₋ₐ₎ (II) where the radicals R may be the same or different and represent a non-hydrolyzable radical which optionally has a functional group, X is as defined above and a is 1, 2 or 3, preferably 1 or 2.

In the above formulae, the hydrolyzable groups X are, for example, hydrogen or halogen (F, Cl, Br or I), alkoxy (preferably C₁₋₆-alkoxy, for example methoxy, ethoxy, n-propoxy, isopropoxy and butoxy), aryloxy (preferably C₆₋₁₀-aryloxy, for example phenoxy), acyloxy (preferably C₁₋₆-acyloxy, for example acetoxy or propionyloxy), alkylcarbonyl (preferably C₂₋₇-alkylcarbonyl, for example acetyl), amino, monoalkylamino or dialkylamino having preferably from 1 to 12, in particular from 1 to 6, carbon atoms in the alkyl group(s).

The non-hydrolyzable radical(s) R is (are), for example, alkyl (preferably C₁₋₆-alkyl, for example methyl, ethyl, n-propyl, isopropyl, n-butyl, s-butyl and t-butyl, pentyl, hexyl or cyclohexyl), alkenyl (preferably C₂₋₆-alkenyl, for example vinyl, 1-propenyl, 2-propenyl and butenyl), alkynyl (preferably C₂₋₆-alkynyl, for example acetylenyl and propargyl) and aryl (preferably C₆₋₁₀-aryl, for example phenyl and naphthyl). The mentioned radicals R and X may optionally have one or more customary substituents, for example halogen, ether, phosphoric acid, sulfonic acid, cyano, amide, mercapto, thio ether or alkoxy groups, as functional groups. The radical R may contain a functional group through which crosslinking is possible. Specific examples of the functional groups of the radical R are epoxy, hydroxyl, amino, monoalkylamino, dialkylamino, carboxyl, allyl, vinyl, acryloyl, acryloyloxy, methacryloyl, methacryloyloxy, cyano, aldehyde and alkylcarbonyl groups. These groups are preferably bonded to the silicon atom via alkylene, alkenylene or arylene bridging groups which may be interrupted by oxygen or sulfur atoms or —NH groups. The bridging groups mentioned are derived, for example, from the abovementioned alkyl, alkenyl or aryl radicals. The bridging groups of the radicals R contain preferably from 1 to 18, in particular from 1 to 8 carbon atoms.

Particularly preferred hydrolyzable silanes of the general formula (I) are tetraalkoxysilanes such as tetramethoxysilane and in particular tetraethoxysilane (TEOS). Particular preference is given to inorganic sols obtained by acidic catalysis, for example TEOS hydrolyzates. Particularly preferred organosilanes of the general formula (II) are methyltriethoxysilane (MTEOS) and MTEOS hydrolyzates, epoxysilanes such as 3-glycidyloxypropyltrimethoxysilane (GPTS), methacryloyl-oxypropyltrim-ethoxysilane and acryloyloxy-propyltrimethoxysilane.

When an organically modified inorganic hybrid material is prepared, it is possible to use exclusively silanes of the formula (II) or a mixture of silanes of the formula (I) and (II). In the case of the inorganic silicon-based sols, exclusively silanes of the formula (I) are used, and fractions of hydrolyzable compounds of the above formula MXₙ are optionally added.

When the inorganic sol consists of discrete oxide particles dispersed in the solvent, they may improve the hardness of the layer. These particles are in particular nanoscale inorganic particles. The particle size (X-ray-determined volume average) is, for example, in the region of ≦200 nm, in particular ≦100 nm, preferably ≦50 nm, for example from 1 nm to 20 nm.

According to the invention, the nanoscale particles used may, for example, be inorganic sols of SiO₂, ZrO₂, GeO₂, CeO₂, ZnO, Ta₂O₅, SnO₂ and Al₂O₃ (in all modifications, especially as boehmite AlO(OH)), preferably sols of SiO₂, Al₂O₃, ZrO₂, GeO₂ and mixtures thereof. Some of these sols are also commercially available, for example silica sols such as the Levasils™ from Bayer AG.

The inorganic or organically modified inorganic matrix-forming material used may also be a combination of such nanoscale particles with inorganic sols or organically modified hybrid materials present in the form of hydrolyzates or (poly)condensates, which are referred to here as nanocomposites.

Optionally, organic monomers, oligomers or polymers of any kind may also be present as organic matrix-forming materials which serve as flexibilizers, these being customary organic binders. They may be used to improve the coatability. In general, they are decomposed photocatalytically after completion of the layer. The oligomers and polymers may have functional groups through which crosslinking is possible. This crosslinking is also possible in some cases for the above-illustrated organically modified inorganic matrix-forming materials. Mixtures of inorganic, organically modified inorganic and/or organic matrix-forming materials are also possible.

Examples of usable organic matrix-forming materials are polymers and/or oligomers which have polar groups such as hydroxyl, primary, secondary or tertiary amino, carboxyl or carboxylate groups. Typical examples are polyvinyl alcohol, polyvinylpyrrolidone, polyacrylamide, polyvinylpyridine, polyallylamine, polyacrylic acid, polyvinyl acetate, polymethylmethacrylic acid, starch, gum arabic, other polymeric alcohols, for example polyethylene-polyvinyl alcohol copolymers, polyethylene glycol, polypropylene glycol and poly(4-vinylphenol) or monomers or oligomers derived therefrom. The polyvinyl alcohol used may be, for example, the commercially available Mowiol™ 18-88 from Hoechst.

The degree of dilution of the dispersion applied in step d) depends on factors including the desired coating thickness. In general, the dispersion has a solids content of less than 50% by weight, in particular less than 20% by weight and preferably less than 10% by weight, for example 2.5% by weight.

The inorganic sol or the organically modified inorganic hybrid material serves not only as a matrix-forming material for the photocatalytic layer, but also for improved layer adhesion. TiO₂ may be present in the layer as a matrix-forming constituent and/or as particles.

Production of the Metal Complex Solutions

The metal complex solutions of the present invention may be prepared in any suitable manner and may have any suitable constituents. Preferably, the metal is silver. In other embodiments the metal is copper, gold, nickel, zinc, aluminum, titanium, chromium, manganese, tungsten, platinum or palladium. In some embodiments the metal is an alloy comprising one or more of silver, copper, gold, nickel, zinc, aluminum, titanium, chromium, manganese, tungsten, platinum or palladium. By way of example, the alloy may comprise steel, brass, bronze or duralumin. The metal may be added to the metal complex in any suitable manner or form. In some embodiments the metal is added to the complex as a salt. In embodiments in which the metal is silver, preferably, the silver is added to the complex as AgNO₃; however, silver may be added to the complex in any suitable form. In preferred embodiments, the silver is added to a mixture of ethyl alcohol (EtOH), isopropyl alcohol, and/or deionized water (or any mixture thereof), but the silver may be solubilized in any suitable solution.

Preferably, a complexing agent is also used in the metal complex solution. The complexing agent may be any suitable compound. In some embodiments the complexing agent stabilizes the metal ions in a manner that enhances the reaction kinetics. In other embodiments the complexing agent keeps the pH-value of a metal complex solution in a desired range. In some embodiments, the complexing agent has a relatively low molecular weight (similar to the compounds identified herein) and/or have a primary, secondary or tertiary amino group. The suitability of a particular complexing agent may be evaluated by the quality of the resulting metal coating, the amount of time required to complete the application of the metal coating, the stability of the metal complex and cost. In some embodiments, the complexing agent is 3-Amino-1,2-propandiol (3-Ap), 2-Amino-1-butanol (2-Abs), 3-Amino-1,2 propandiol/2-Amino-1-butanol (3-Ap/2-Ab), Tris(hydroxymethyl)-aminomethane (TRIS), NH3, Nicotinamide, or 6-aminohexanoic acid. TRIS is the most preferred complexing agent because the resulting silver complex has increased stability and may be usable for an extended period. In some embodiments the complexing agent results in a complex that may be used in one, two, three, four, five or more days after the complex is formed.

TABLE 1
Exemplary complexing agents and amounts
used for a silver complex solution

| complexing agent | amount in mmol | amount in g |
|---|---|---|
| 3-Amino-1,2-propandiol (3-Ap) | 1.06 | 0.0966 |
| 2-Amino-1-butanol (2-Ab) | 1.06 | 0.0945 |
| 3-Amino-1,2-propandiol/2- | 0.35/0.7 | 0.0319/0.0624 |
| Amino-1-butanol | | |
| (3-Ap/2-Ab) | | |
| Tris (hydroxymethyl)- | 1.06 | 0.1284 |
| aminomethane (TRIS) | | |

The various elements of the silver complex solution may be added in any suitable order and at any suitable concentrations and amounts. Preferably, the complexing agents are first solubilized in a mixture of deionized water and EtOH and/or isopropyl alcohol. In such embodiments the mixture can have any suitable amounts of EtOH and/or isopropyl alcohol and/or deionized water. More preferably, the complexing agents are solubilized in 27.75 mmol (0.5 g) deionized H₂O and 10.85 mmol (0.5 g) EtOH or 0.5 mmol 27.75 mmol (0.5 g) deionized H₂O and 10.85 mmol (0.5 g) EtOH. Preferably the metal and the complexing agent are present in a molar ratio of 2.12 to 1, but any suitable ratio may be used. Preferably the metal compound is added to the complexing agent solution. In some embodiments the metal compound is added to the complexing agent solution under stirring. In some embodiments the temperature of the complexing agent solution is about 25 degrees C. or lower, to prevent the reduction reaction from initiating. The solubility of the complexing solution of course depends upon the temperature and the particular solvent(s) used,

Application of the Metal Complexes to the Substrate

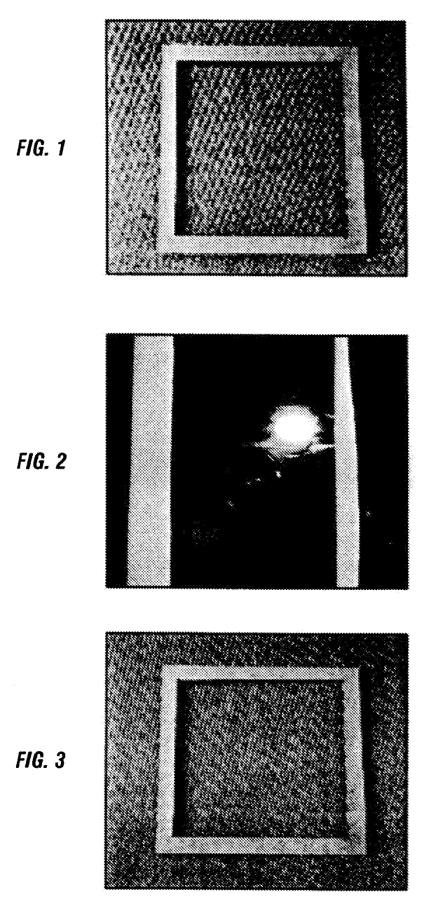

The metal complex may be applied to the substrate in any suitable manner. In some embodiments, the solution is applied by first placing a band frame (see FIG. 1) on to the substrate. The metal complex is then added to the internal volume of the band frame. The band frame may be made of any suitable material. In some embodiments, the band frame is made of an elastic material. The hand frame may be any suitable length, width and thickness. Varying the dimensions of the band frame alters the volume of metal complex that may be applied. In some embodiments the length of the band frame is from about 1 cm to about 25 cm. In other embodiments the length of the band frame is from about 4 cm to about 15 cm. In some embodiments, the width of the band frame is from about 1 cm to about 25 cm. In other embodiments the width of the band frame is from about 4 cm to about 15 cm. In some embodiments, the thickness of the band frame is from about 25 micrometers to about 5 millimeters. In other embodiments, the thickness of the band frame is from about 25 micrometers to about 1000 micrometers.

In some embodiments, the metal complex is added to the internal volume of the band frame by any suitable method. In some embodiments, the metal complex is applied in a specific pattern. For example, the metal complex may be applied only to specific portions of the substrate. In addition, the metal complex may be added to a band frame having a particular configuration, the configuration providing a pattern or the like.

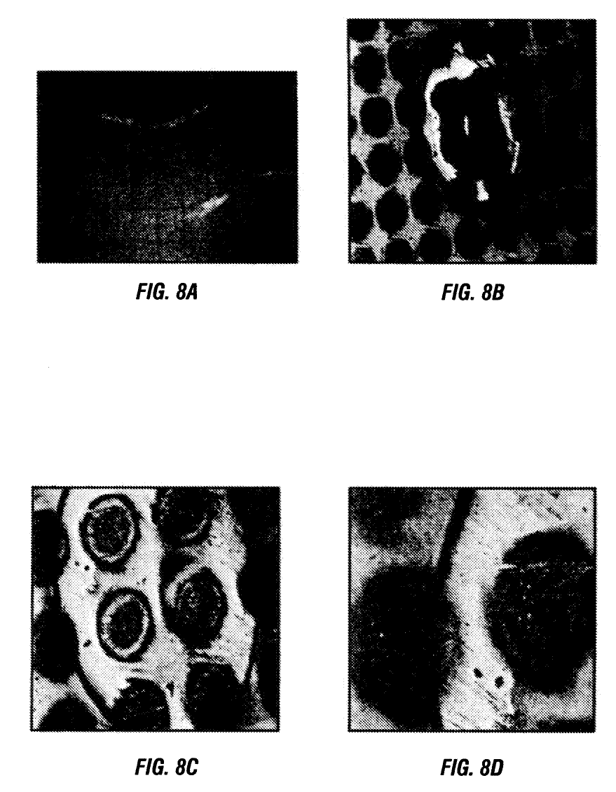

In other embodiments the metal complex is applied to a broad area, but only certain portions of the metal complex are exposed to a reducing agent (e.g., a light source) and/or an initiator. For example, a laser light may be used to selectively reduce certain portions of the substrate to form any useful or desired pattern (see, e.g., FIGS. 8a-d) In certain embodiments, additional elements are placed on the band frame, either before or after addition of the metal complex. The additional elements may be made of any suitable material and may have any suitable length, width and thickness. In some embodiments, the additional elements have portions that permit substantial passage of light and other portions that do not permit substantial passage of light. In some such embodiments, the additional element includes an element that provides a certain pattern (or set of structures or microstructures) for the formation of the metal coating. The pattern may be any suitable, useful or desired pattern. (see, e.g., FIGS. 5 and 7). In some embodiments, the additional elements may be distance pieces and/or a mask. In some embodiments, the mask is made of metal or quartz glass. In other embodiments the mask is metallic and has blanked out lines of varying thicknesses. (see, e.g., FIGS. 4 and 5). In some embodiments the blanked out lines have a thickness of from about 1 mm to about 6 mm. In further embodiments, the blanked out lines have a thickness of from about 0.5 mm to about 100 mm. In some embodiments, the blanked out lines result in a substrate having a plurality conducting paths of different widths. Once the additional element is placed upon the band frame, the metallic complex may be added by any suitable method. By way of example, the metal complex may be added by flooding or by spraying.

In some embodiments, once the metal complex is added to the substrate, it is covered by a covering element. In various embodiments, the covering element is at least partially or punctually transparent to UV-light (energy more than 3.2 eV). In some embodiments, the covering element is polymethyl methacrylate (PMMA) foil. In some embodiments, the PMMA-foil is from about 75 μm to about 5 mm thick. In other embodiments, the PMMA-foil is about 1 mm thick. In some embodiments, the PMMA-foil is laminated. In some embodiments, a mask is placed on top of the covering element. In some embodiments the mask is a quartz glass mask such as that illustrated in FIG. 7. In such embodiments the metal complex is then irradiated with UV light, as will be discussed in greater detail below.

In some embodiments, once the metal complex is applied, it is subjected to a reducing agent that is an environmental condition that reduces or facilitates reduction of the metal complex. In some embodiments, the environmental condition is an electromagnetic wave with a wavelength λ<400 nm (for example WV or laser light). In particular, in embodiments where the substrate is coated with an initiator material, the substrate (with the metal complex applied) is exposed to an environmental condition that will facilitate a photoreduction of the metal complex. In preferred embodiments this environmental condition is laser or UV light.

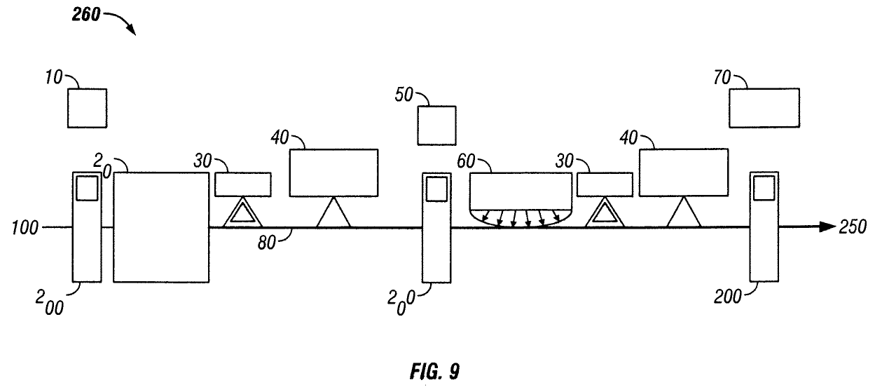

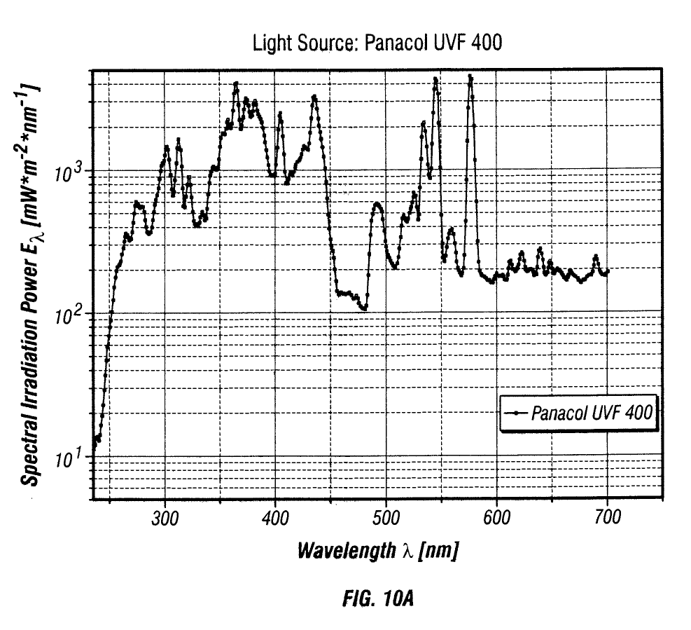

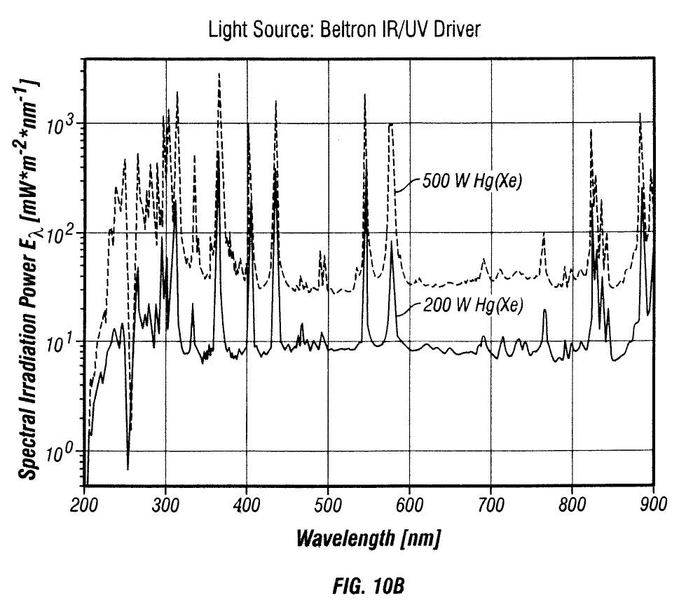

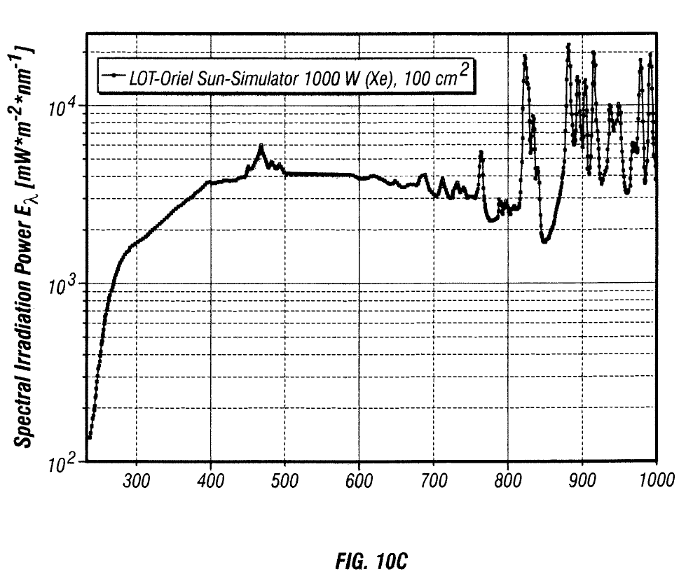

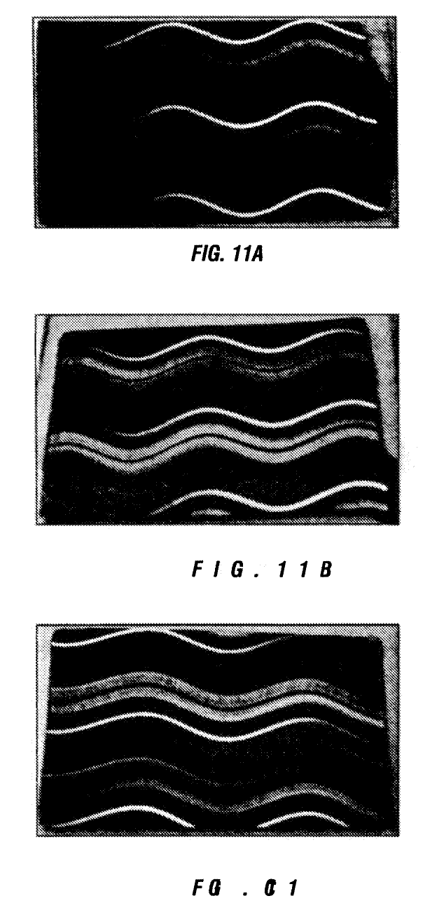

In some embodiments, the initiator layer is optionally and preferably activated by irradiation with visible and/or UV light. Any light source suitable for providing such light may be used. In some embodiments, the irradiation is by a high-pressure mercury lamp of 700 W for from 1 to 5 minutes or a xenon lamp of 750 W for from 1 to 10 minutes. High-pressure mercury lamps are suitable as they have a relatively high proportion of UV light; the spectrum of xenon lamps corresponds approximately to that of sunlight. In other embodiments the light source may be one of a Panacol UVF 400 (400 W Fe(Hg) (see FIG. 9), Beltron 2*5000 W Hg(Xe) (high pressure), Beltron IR/UV dryer Hg(Xe) (see FIG. 10), LOT Oriel Sun Simulator 1000 W Xe light collimated onto 100 cm² (see FIG. 11) or a LOT Oriel Sun Simulator 1000 W Hg(Xe) light collimated onto 100 cm² (high UV intensity). FIGS. 10a-c depict the spectral characteristics of certain of the possible light sources.

The light source may be placed any suitable distance from the substrate. Any distance is possible. For divergent light one has to keep in mind that the light intensity on the irradiated substrate decreases directly proportional by square with increased distance. In some embodiments the light source is from about 25 mm to about 500 mm from the substrate. In other embodiments the light source is about 80 mm to about 170 mm from the substrate. In some embodiments, the wavelength is 250-410 nm (intensity 550 W*m⁻²) and the distance from the light source to the substrate is 170 mm. In some embodiments, the wavelength is 220-260 nm (intensity 170 W*m⁻²) and the distance from the light source to the substrate is 80 mm. In some embodiments, the wavelength is 260-320 nm (intensity 640 W*m⁻²) and the distance from the light source to the substrate is 80 mm. In some embodiments, the wavelength is 350-450 nm (intensity 550 W*m⁻²) and the distance from the light source to the substrate is 80 mm.

The decollimation angle of the light source may be any suitable angle. In some embodiments, the decollimation angle of the light source should be kept as small as possible to achieve a high resolution. In some embodiments the collimation angle of the light source is (±°) 3.8.

The beam size of the light source may be any suitable size. In some embodiments the beam size is 100×100 mm².

The light from the light source is applied to the substrate for a suitable amount of time. Generally, a suitable amount of time is the amount of time required to fully reduce the metal complex and may depend upon the wavelength and intensity of the light source, the size of the substrate and the distance from the light source to the substrate. In some embodiments a suitable amount of time is the time required to form a highly reflective coating. In some embodiments a suitable amount of time is the time required to form a metal coating that conducts electricity. In some embodiments the time required is from 5 seconds to 10 minutes. In other embodiments the time required is from 20 seconds to 3 minutes.

In some embodiments the activation is by laser. Any suitable laser light source may be used. In some such embodiments, an Argon ion laser (351 nm) with 10 mW and speed of 2 mm/s. (see FIGS. 8a-d)

In some embodiments, after the metal complex is reduced, the metal complex coated substrate is further treated. In some embodiments, any excess metal complex is washed off. In some embodiments, the excess metal complex is washed off using deionized water, but any suitable substance may be used. In such embodiments the metal complex coated substrate is dried, e.g., using compressed air, an oven, or permitted to dry at room temperature. In some embodiments a protective film is added to the metal complex coated substrate. Preferably, the protective film is substantially impermeable to water and oxygen to prevent oxidation of the metal. In some embodiments the protective film prevents passage of substantial UV light to the metal.

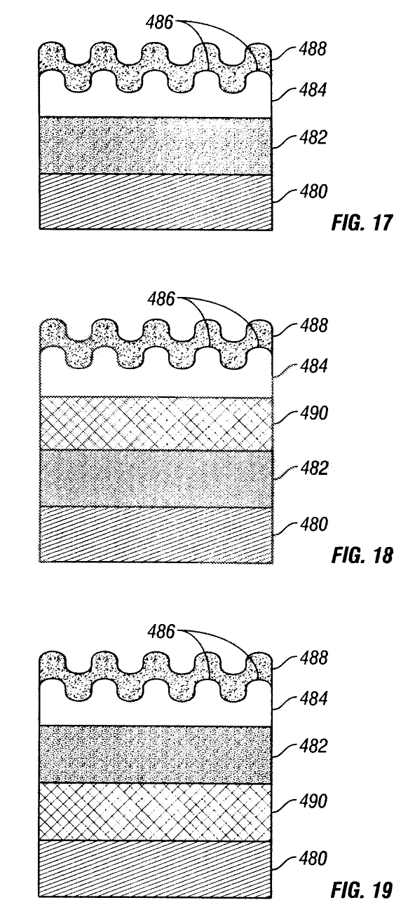

FIGS. 17-19 depict exemplary articles produced by the methods and systems of the present invention. Referring to FIG. 17, a substrate 480 is selectively coated with a metallic coating 82 such as a hot-stamping metallized foil, a cold-stamping metallized foil, metallic inks or metallic lacquers. In addition, a coating 484 having embossed surface reliefs 486 is applied on top of metallic coating 482, and then high refractive coating 488 such as a protective or printed layer may (or may not) be applied on top of coating 484. In particular, if coating 484 is an high refractive index surface relief (HRISR) or low refractive index surface reliefs (LRISR) coating, then there is no need to apply a special high refractive coating (coating 488) because such HRISR and LRISR coatings intrinsically contain the refractive index properties that are necessary to keep the holography viewable despite any printing on top of the coating 484. On the other hand, if the coating 484 does not comprise an HRISR or LRISR coating, then the high refractive coating 488 preferably is applied on top of coating 484. In this case, coating 488 preferably follows the topography of the surface reliefs 486 such that the thickness of coating 488 is substantially uniform o contrast, if the coating 488 were substantially flat, the holography would lose its visibility since the surface reliefs would be eliminated. Byway of example, the thickness of the coating 488 may be approximately 50 nm. The coating 488 may comprise a protective or printed layer such as an ink, lacquer, adhesive or laminate.

Referring to FIG. 18, substrate 480 is selectively coated with a metallic coating 482 such as a hot-stamping metallized foil, a cold-stamping metallized foil, metallic inks or metallic lacquers. Then, a printed layer 490 is applied on top of metallic coating 482, and coating 484 having embossed surface reliefs 486 is applied on top of printed layer 490. A high refractive coating 488 such as a protective or printed layer may (or may not) be applied on top of coating 484. More particularly, if coating 484 is an HRISR or LRISR coating, then it is unnecessary to have a special high refractive coating (coating 488) because HRISR and LRISR coatings include the refractive index properties that are necessary to keep the holography viewable despite any printing on top of the coating 484. Otherwise, if the coating 484 does not comprise an HRISR or LRISR coating, then the high refractive coating 488 preferably is applied on top of coating 484. The coating 488 preferably follows the topography of the surface reliefs 86, thus preserving the visibility of the holography.

Referring to FIG. 19, printed layer 490 is applied directly on top of substrate 480, and then metallic coating 82 is applied on top of printed layer 490. A coating 484 having surface reliefs 86 is applied on top of metallic coating 82, and then coating 488 such as a protective or printed layer may or may not be applied on top of the coating 484. Similar to the embodiments of FIGS. 17 and 18, if coating 484 is an HRISR or LRISR coating, then it is not necessary to apply a special high refractive coating (coating 488) because HRISR and LRISR coatings inherently include the refractive index properties that are necessary to keep the surface reliefs 86 viewable despite any printing on top of the coating 484. Contrariwise, if the coating 484 does not comprise an HRISR or LRISR coatings, then the high refractive coating 488 preferably is applied on top of coating 484. The coating 488 preferably follows the topography of the surface reliefs 486 such that the surface reliefs 486 remain visible.

Conductivity

In some embodiments, the resulting metal coating conducts electricity. The resistance generally depends upon the temperature under which the substrate was cured, the thickness of the metal coating, the metal used, the oxidation method and the irradiation time. In various embodiments the ohmic resistance was from about 761 mΩ up to 173 kΩ (as measured by a 4-point method (pU/I modus)). Embodiments using polyamide substrates with a titania layer applied by flooding, dried at 270° C. and a relatively thick silver coating applied using an elastic band frame and irradiated for 60 seconds showed the lowest resistance of the tested embodiments. Generally, the resistance may depends on different parameters like type of titania used, concentration and film thickness of the metal complex, irradiation time and intensity, and/or temperature post-treatment.

Systems

In some embodiments, the present invention is a system for applying a metal coating to a substrate. In some embodiments, the systems of the present invention apply a metal coating to a substrate in accordance with embodiments of the methods of the present invention. An exemplary system is illustrated in FIG. 9.

FIG. 9 depicts a system 260 having various elements, including substrate coating applicator 10, heating element 20, substrate cleaner 3 0, substrate dryer 40, metal complex applicator 50, light source 60, protective film applicator 70 and transport element 80 having a proximal end 100 and distal end 250. Although the elements are presented in a linear fashion and in a particular order, the elements may have any suitable arrangement. In some embodiments the systems of the present invention have each of the above-elements. In other embodiments, systems of the present invention have additional elements. In further embodiments, systems of the present invention do not have each of the above elements. In some embodiments one or more of the above-elements is combined with another one or more of the above-elements. FIG. 9 also depicts substrate 200 as it moves through the depicted system 260.

Substrate coating applicator 10 may be any device or mechanism that may apply a coating to a substrate 200 as described herein. In some embodiments, coating applicator 10 may apply a coating of a TiO₂ solution to the substrate 200. In some embodiments coating applicator 10 maybe adjustable such that it can apply coatings of various thicknesses to substrate 200. In some embodiments coating applicator 10 is also capable of mixing and storing the coating material to be applied to substrate 200.

Heating element 20 may be any device or mechanism that applies heat to the substrate 200. In some embodiments heating element 20 applies heat at the temperatures and durations as described herein. In some embodiments heating element 20 is adjustable such that it may apply varying temperatures to substrate 200. In some embodiments heating element 20 is an oven.

Substrate cleaner 30 may be any device or mechanism that cleans excess materials off of substrate 200. In some embodiments substrate cleaner 30 may be any device or mechanism that cleans the substrate 200 as described herein. In some embodiments substrate cleaner 30 is a device or mechanism that applies deionized water to substrate 200.

Substrate dryer 40 may be any device or mechanism that aids or facilitates the drying of substrate 200. In some embodiments substrate dryer 40 is any mechanism or device that dries substrate 200 as described herein. Substrate dryer 40 may apply heat or pressure to substrate 200. In some embodiments substrate dryer 40 applies compressed air to substrate 200.

Metal complex applicator 50 may be any device or mechanism that may apply a coating to a substrate 200 as described herein. In some embodiments, metal complex applicator 50 may apply a coating of a silver complex solution to the substrate 200. Metal complex applicator 50 may be adjustable such that it can apply coatings of various thickness to substrate 200. In some embodiments metal complex applicator 50 is also capable of mixing and storing the metal complex material to be applied to substrate 200, and or the individual elements of the metal complex material to be applied to substrate 200.

Light source 60 may be any device or mechanism that may apply light to substrate 200. Light source 60 may be located any suitable distance from substrate 200. In some embodiments light source 60 is any device or mechanism that can supply the light described herein. Light source 60 may be any of the light sources described herein. In some embodiments light source 60 may supply visible, UV and/or laser light.

Protective film applicator 70 may be any device or mechanism that may apply a protective film to substrate 200. In some embodiments protective film applicator 70 may apply a protective film in a manner similar to the manner in which coating applicator 10 and metal complex applicator 50 apply the coating and metal complex, respectively.

Transport element 80 may be any device or mechanism that may move the substrate 200 through system 260 in a manner that permits the substrate 200 to be modified or acted upon by the various system elements. In some embodiments transport element 80 moves substrate from proximal end 100 to distal end 500. For example, the transport element may be a conveyor, pulley system or roller system.

Substrate 200 may be any suitable material, as is described herein.

In some embodiments system 260 may be connected to another system. For example, system 260 could be connected to a system that is capable of printing surface reliefs, as is described in U.S. patent application Ser. No. 11/551,205 filed on Oct. 19, 2006 and entitled “Substrates and Articles Having Selective Printed Surface Reliefs” (the entire contents of which are incorporated herein by reference in their entirety). In some embodiments system 260 may be connected to one or more of the elements of system 300. In other embodiments system 260 may be used, in whole or in relevant part, as first printing station 305. In other embodiments, a system similar to second printing station 315 may be used to apply surface reliefs to a substrate and system 260 or first printing station 305 may be used to add a metallic mirror finish.

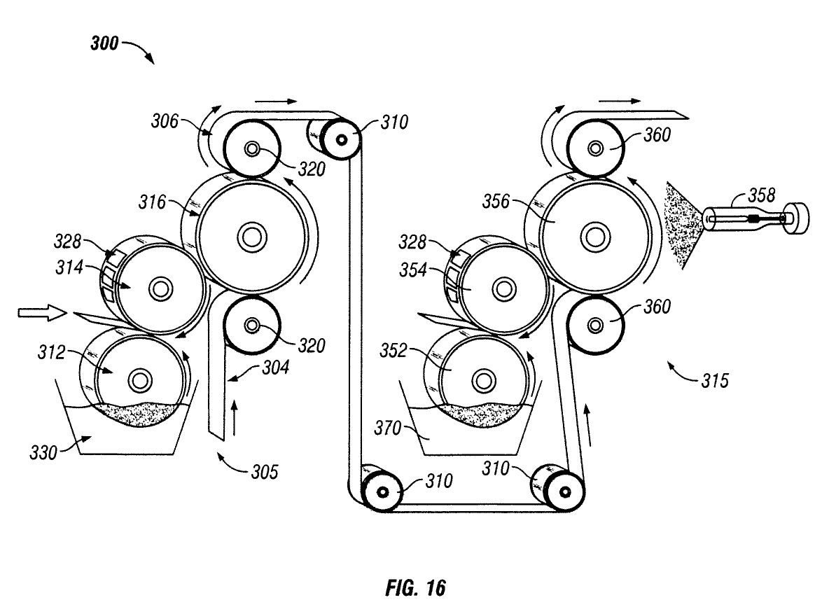

FIG. 16 depicts another embodiment of a system of the present invention. System 300 may print mirrored surface reliefs on a substrate 304 using conventional printing equipment. The system 300 comprises a first printing station 305 for applying a mirrored finish 306 to substrate 304, and a second printing station 315 for curing surface reliefs 328 on top of mirrored finish 306. The first and second printing stations are interconnected by a web including substrate 304 and rollers 310. First printing station 305 comprises anilox roller 312, flexographic tool 314, temperature controlled mirror finish roller 316, printing rollers 320 and temperature-controlled tray 330, whereas second printing station 315 comprises anilox roller 352, flexographic tool 354, surface relief tool 356, curing tool 358, printing rollers 360 and temperature-controlled tray 370.

The flexographic tools 314, 354 preferably each comprise a flexographic printing sleeve or plate attached to a master roller that is temperature controlled to a predetermined temperature. Flexographic tool 354 facilitates the transfer of complex shapes (raised sections 328) onto surface relief tool 356. The temperature-controlled tray 330 is designed to feed anilox roller 312, which carries metallic ink that will be cured against mirror finish roller 316. Temperature controlled tray 370 is designed to feed anilox roller 352, which carries a high refractive index material onto flexographic tools 314, 354, respectfully. In operation, the raised areas 328 on the flexographic tool 354 deposit the HRISR or LRISR coating onto the surface of surface relief tool 356 in substantially perfect register to the surface reliefs in surface relief tool 356. The substrate is fed between surface relief tool 356 and printing rollers 360 such that the HRISR or LRISR coating is pressed against surface relief tool 356 as it is being cured by curing tool 358.

The system of FIG. 16 may be used for “pad printing” or tampography, wherein a metallic base is applied at the first station, and a surface reliefs with a refractive index coating is applied at the second station. The use of pad printing or tampography allows the surface reliefs to be imparted onto objects having intricate shapes. Otherwise, the surface reliefs may only be imparted on substantially flat substrates.

Another method for producing reflective surface reliefs involves: (1) applying metallic ink and or lacquer that it is cured against a mirror finish chilled roller at a first station; and (2) applying a high reflective index ink and/or lacquer that is cured on top of the mirror finish at a second station. Particularly, since the roller has a mirror finish, the metallic ink will become a mirror finish as well. Any type of texture in the macro relief may be imparted onto the mirror finish flexographic roller, and any type of texture may be imparted onto the metallic UV/EB inks (e.g., brushed films, polished aluminum surfaces and engraved stamping dies). The imparting of texture may be used in the production of labels, packaging, shrinkable films, greeting cards, and other products. The application of texture to the mirror finish may require the use of an additional curing tool.

### EXAMPLE 1

Hydrothermal Preparation of TiO₂ (Anatase)

9.6 g (0.034 mol) of titanium isopropoxide (Ti(OⁱPr)₄) is added to 14.5 g of n-propanol and, after stirring at room temperature for 5 minutes, admixed with 0.67 g (0.0068 mol) of 37% HCl. After 20 minutes, 0.712 g (0.063 mol) of water is added with intensive stirring. The mixture is subsequently diluted with 41.9 g of n-propanol, and then treated at 250° C. and 200 bar of pressure for 7 hours. The resulting anatase is centrifuged off and dried at 50° C. and 10 mbar.

### EXAMPLE 2

Hydrothermal Preparation of Doped TiO₂ (Anatase, Sn (CH₃CO₂)₄ Dopant)

9.6 g (0.034 mol) of titanium isopropoxide (Ti(OⁱPr)₄) is added to 14.5 g of n-propanol and, after stirring at room temperature for 5 minutes, admixed with 0.67 g (0.0068 mol) of 37% HCl. After 20 minutes, 0.712 g (0.063 mol) of water is added with intensive stirring. The mixture is subsequently diluted with 41.9 g of n-propanol, then the mixture is admixed with 0.635 g (0.0018 mol) of Sn(CH₃CO₂)₄ and treated at 250° C. and 200 bar for 7 hours. The resulting anatase is centrifuged off and dried at 50° C. and 10 mbar.

### EXAMPLE 3

Hydrothermal Preparation of Doped TiO₂ (Anatase, WO₃ Dopant)

9.6 g (0.034 mol) of titanium isopropoxide (Ti(OⁱPr)₄) is added to 14.5 g of n-propanol and, after stirring at room temperature for 5 minutes, admixed with 0.67 g (0.0068 mol) of 37% HCl. After 20 minutes, 0.712 g (0.063 mol) of water is added with intensive stirring. The mixture is subsequently diluted with 41.9 g of n-propanol, then the mixture is admixed with 0.039 g (0.00017 mol) of WO₃ and treated at 250° C. and 200 bar for 7 hours. The resulting anatase is centrifuged off and dried at 50° C. and 10 mbar.

### EXAMPLE 4

Surface Modification of TiO₂ (Anatase) Powder with FTS

Of the TiO₂ powders prepared by Examples 1 to 3, in each case 1.0 g thereof is stirred with 8.67 g of toluene and then admixed with 0.077 g of FTS. After stirring for 2 hours, the toluene is removed in a rotary evaporator.

### EXAMPLE 5

Surface Modification of TiO₂ (Anatase) Powder with HDTMS

Of the TiO₂ powders prepared by Examples 1 to 3, in each case 1.0 g thereof is stirred with 8.67 g of toluene and then admixed with 0.312 g of HDTMS. After stirring for 2 hours, the toluene is removed in a rotary evaporator.

### EXAMPLE 6

Production of a Photocatalytic Layer with Undoped TiO₂

To prepare a GPTS hydrolyzate, 23.6 g (0.1 mol) of GPTS is admixed with 5.4 g (0.3 mol) of water. The mixture is subsequently stirred at room temperature overnight. 0.05 g of the ETS-modified, undoped TiO₂ powder prepared by Example 4 is dispersed in 1.56 g of MEK (methyl ethyl ketone) and then admixed with 0.44 g of formamide. The resulting dispersion is mixed with stirring with 4.14 g of the GPTS hydrolyzate prepared. The resulting coating composition is applied to polycarbonate plaques (PC plaques) of 10 cm×10 cm by means of a spin coating apparatus (spincoater) at 1000 rpm. Subsequently, the plaques are hardened at 128° C. for 1 hour. The coating thicknesses are from 2 to 3 μm. The contact angle of the resulting layers with respect to water is 101°;

The coated PC plaques are irradiated with a xenon lamp (750 W) for 4 minutes. After the coating, the contact angle of the PC plaques toward water is only 10°. To determine the photocatalytic activity of the resulting PC plates, the change in the light absorption with time at 553 nm of a Rhodamine B solution is determined. For this purpose, 20 ml of an aqueous Rhodamine B solution (concentration 6 ppm) is contacted with the PC plaque which is irradiated with a xenon lamp (750 W). The absorption of the Rhodamine B solution at 553 nm is measured at intervals in order to monitor the degradation of Rhodamine B. After approx. one hour, all of the Rhodamine B has decomposed.

### EXAMPLE 7

Production of a Photocatalytic Layer with Sn-Doped TiO₂

0.05 g of the HDTMS-modified, Sn-doped TiO₂ powder prepared in Example 5 is dispersed in 1.56 g of petroleum ether and then admixed with 0.44 g of formamide. The resulting dispersion is mixed with stirring with 4.14 g of the GPTS hydrolyzate prepared as in Example 6.

The resulting coating composition is applied to polycarbonate plaques (PC plaques) of 10 cm×10 cm by means of a spin coating apparatus (spincoater) at 1000 rpm. Subsequently, the plaques are hardened at 128° C. for 1 hour. The layer thicknesses are from 2 to 3 μm. The contact angle of the resulting layers with respect to water is 92°

The coated PC plaques are irradiated with a xenon lamp (750 W) for 4 minutes. After the irradiation, the contact angle of the PC plaques toward water was less than 10°. The photocatalytic activity of the resulting PC plaques is determined in the same experimental setup as in Example 6 by determining the light absorption at 553 nm of a Rhodamine B solution. All of the Rhodamine B has decomposed after about 35 minutes.

### EXAMPLE 8

Preparation of Photocatalytic Layers with TEOS Hydrolyzate

To prepare a TEOS hydrolyzate, 12.36 g (0.0594 mol) of TEOS in 15.96 g of ethanol is admixed with 9.06 g of water. To this is added with stirring 0.2 g of concentrated (37%) HCl. After stirring for 1 h, 0.28 g of GPTS is added and the mixture is stirred at room temperature overnight. A TEOS hydrolyzate with 2 mol % of GPTS is obtained. Of the FTS-modified TiO₂ powders prepared in Example 4 (undoped, Sn-doped and W-doped), in each case a 2.5 percent by weight solution thereof in methyl ethyl ketone is prepared and mixed with 0.2 g of the TEOS hydrolyzate prepared which contains 2 mol % of GPTS (molar Ti:Si ratio=10:5).

The resulting coating composition is applied to polycarbonate plaques (PC plaques) of 10 cm×10 cm by means of a spin coating apparatus. Subsequently, the plaques are hardened at 128° C. for 1 hour.

### EXAMPLE 9

Determination of the Photocatalytic Activity of Layers with Doped TiO₂

To determine the photocatalytic activity, layers with doped TiO₂ are investigated. For this purpose, Sn-doped TiO₂ powder (Sn(IV)), W-doped TiO₂ powder (W(VI)), Fe-doped TiO₂ powder (Fe(III)) and In-doped TiO₂ powder (In(III)) are used in different ratios of Ti to doping metal. The Sn— and W-doped TiO₂ powders are prepared with Sn(CH₃CO₂)₄ and WO₃ in accordance with Examples 2 and 3, and the used amounts are varied in accordance with the desired ratio of Ti to dopant (from 0.5 to 10 mol % of dopant). In an analogous manner, doped TiO₂ powders are prepared with FeCl₃ and In₂O₃. For comparison, unmodified anatase is also prepared in each case under the same conditions. Of the doped TiO₂ powders prepared, in each case a 2.5 percent by weight solution in methyl ethyl ketone is prepared and mixed with 0.2 g of TEOS hydrolyzate prepared as in Example 8 which contains 2 mol % of GPTS.

The resulting coating composition is applied to polycarbonate plaques (PC plaques) by means of a spin coating apparatus. The plaques are hardened at 128° C. for 1 hour.

The photocatalytic activity is again determined with a Rhodamine B solution (6 ppm in H₂O). The coated plaques are each contacted with 20 ml of the Rhodamine B solution and then irradiated with UV light for 10 minutes. Thereafter, the absorption of the Rhodamine B solution is measured at 553 nm. For comparison, measurements on Rhodamine B are also carried out in the same manner without contact with photocatalytic layers and in contact with undoped anatase. The results are listed in the table which follows. It is evident therefrom that doping can in some cases achieve distinctly more rapid degradation rates.

TABLE 2
Absorption at 553 nm at 10 min of UV irradiation

| | |
|---|---|
| Amount | Dopant |

| (mol %) | Fe(III) | W(VI) | Sn(IV) | In(III) |
|---|---|---|---|---|
| —* | 1.46 | 1.42 | 1.08 | 1.07 |
| 0** | 0.24 | 0.31 | 0.125 | 0.12 |
| 0.5 | 0.31 | 0.04 | 0.065 | 0.009 |
| 1.0 | 0.46 | 0.03 | 0.103 | −0.043 |
| 5 | 0.27 | 0.284 | −0.06 | 0.023 |
| 10 | 0.084 | 0.20 | −0.08 | 0.084 |

*measurement without photocatalytic layer
**undoped anatase

### EXAMPLE 10

TiO₂ (Anatase) Preparation Under Reflux

19.2 g (0.068 mol) of titanium isopropoxide (Ti(OⁱPr)₄) is added to 29.02 g of 1-pentanol and, after stirring at room temperature for 5 minutes, admixed with 1.33 g (0.0136 mol) of 37% HCl. After 20 minutes, 1.42 g (0.079 mol) of water is added rapidly with intensive stirring and stirred further at room temperature for 20 minutes. The mixture is subsequently boiled under reflux at 132° C. for 16 hours. The resulting anatase is centrifuged off and dried at 50° C. and 10 mbar.

Surface Modification of Refluxed TiO₂ (Anatase) Powder with TODA

Of the TiO₂ powder obtained above, in each case 1 g thereof is stirred with 4 g of water and then admixed with 0.2 g of TODA (trioxadecanoic acid). After ultrasound treatment for 10 minutes, a transparent solution is obtained.

Dispersion of Refluxed TiO₂ (Anatase) Powder with Toluene

Of the TiO₂ powder obtained above, in each case 1 g thereof is stirred with 1.5 g of toluene. After ultrasonic treatment for 1 minute, a transparent solution is obtained.

### EXAMPLE 11

Polyimide foil was used for the substrate. TRIS was used as the complexing agent. Silver was the metal used in the metal complex. The initiator was TiO₂ produced as described herein. After coating the substrate with 1 wt % TiO₂-solution in H₂0/EtOH (ratio of H₂0:EtOH→30:70 wt %) by flooding, the TiO₂-film was dried at ˜270° C. for 15 minutes in an oven. The silver complex was formed by solubilizing the TRIS in 27.75 mmol (0.5 g) deionized water and 10.85 mmol (0.5 g) EtOH. Separately 0.5 mmol (0.0845 g) AgNO₃ was solubilized in 27.75 mmol (0.5 g) deionized water and 10.85 mmol (0.5 g) EtOH. The AgNO₃ solution was added to the complexing agent solution under stirring.

The silver complex was applied to the substrate in the following manner. An elastic band frame (see FIG. 1) approximately 4 cm×4 cm was laid on the coated substrate. Then 30 pm to 2 mm of the silver complex was added to the internal volume of the band frame. The amount of complex-solution in the rubber frame was between 30 pm and 2 mm. After that the substrate was irradiated with UV-light for 1 minute. The UV light was from a mercury xenon lamp that provided 55 mW/cm² in the spectral range from 25 0 to 410 nanometers (as measured by a digital “UV Integrator” sold by Beltron). The remaining silver complex was washed off with deionized water and the substrate was dried by application of compressed air.

The result was a high reflective silver film as depicted in FIG. 2. Note the reflection of the camera seen in the film. In addition, the mirror coating was shown to be conductive.

In addition, during the above procedure it was noted that a high reflective film had already developed under only 20 seconds of irradiation with UV light.

### EXAMPLE 12

PET foil was used for the substrate. TRIS was taken for complexing agent and silver as the metal. The silver complex was formed as described in Example 11. After coating with 1 wt % TiO₂-solution in H₂0/EtOH (ratio of H₂0:EtOH→30:70 wt %) by roller dip coating, the TiO₂-film was dried at 120° C. for 1 hour in an oven. The TiO₂-layer was flushed with deionized water and dried. The silver complex was applied as described in Example 11. UV light was applied as described in Example 11 for 1 minute. The remaining silver complex was washed off with deionized water and the substrate was dried by application of compressed air.

The result was a mirror-like high reflective film as described in Example 11. Tests showed that it is not absolutely necessary to dry the TiO₂-film at high temperature in an oven. It is also possible to dry it at room temperature for about 1 hour. After that the TiO₂ layer was flushed with deionized water. The obtained silver coating was also reflective, but observably thinner, not as bright and more heterogeneous.

### EXAMPLE 13

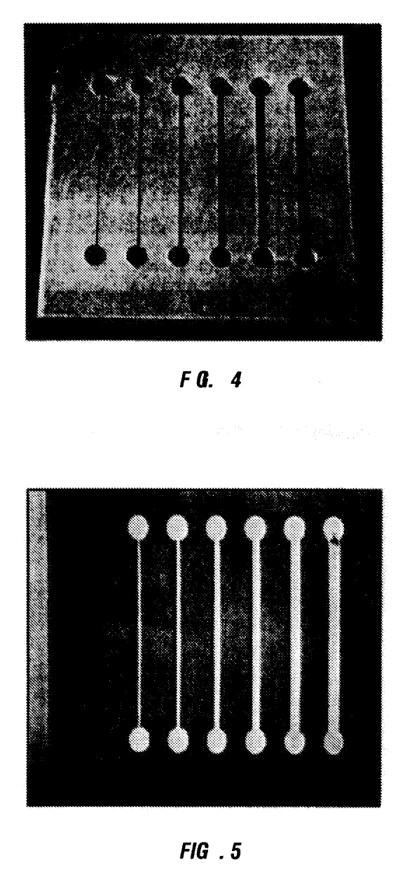

(a) Polyimide foil was used for substrate. TRIS was used as the complexing agent and silver as the metal. TiO₂ was applied to the substrate by flooding of 1 wt % TiO₂-solution in H₂0/EtOH 20:80 wt %) and was dried at 270° C. for 15 minutes. Afterwards an elastic band frame of 15 cm×15 cm (see FIG. 3) was laid on the coated foil and the silver complex was applied to the internal volume. Then distance pieces and a metallic mask having blanked out lines of different thicknesses (see FIG. 4) were put on the frame. This structure was irradiated with UV-light for 1 minute as described in Example 11 and the remaining silver was removed as described in Example 11.

(b) The procedure was performed as described in (a) above, but the complexing agent was 3-Ap instead of TRIS.

(c) The procedure was performed as described in (a) above, but the complexing agent was 2-Ab instead of TRIS.

(d) The procedure was performed as described in (a) above, but the complexing agent was a mixture of 3Ap and 2Ab instead of TRIS.

In all cases high reflective silver depositions (see FIG. 5) were achieved and (similar to previous examples) the silver film was shown to conduct electric current.

### EXAMPLE 14

(a) PET foil was used for substrate. TRIS was used as the complexing agent and silver as the metal. TiO₂ was applied to the substrate by flooding of 1 wt % TiO₂-solution in H₂0/EtOH→20:80 wt % and was dried at 120° C. for 1 hour. Afterwards the TiO₂-layer was flushed with deionized water and dried. The silver complex was applied as in Example 13. The irradiation also occurred with UV-light for 1 minute through the metallic mask (see FIG. 4) as described in Example 13. The remaining silver was removed and dried as in Example 11.

(b) The procedure was exactly the same as under (a), but 3-Ap was used as the complexing agent instead of TRIS.

(c) The procedure was exactly the same as under (a), but 2-Ab was used as the complexing agent instead of TRIS.

(d) The procedure was exactly the same as under (a), but the mixture of 3-Ap and 2-Ab was used as the complexing agent instead of TRIS.

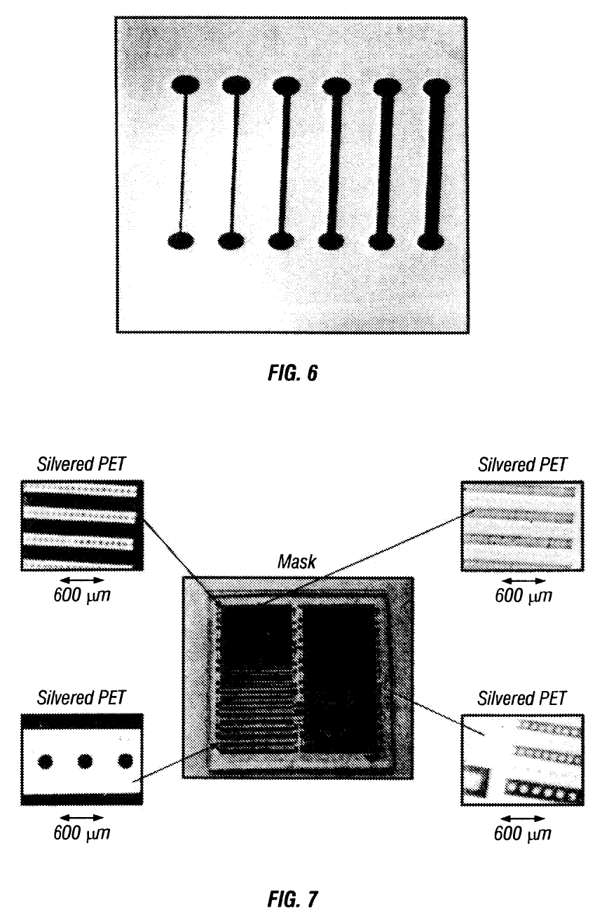

The result in each case was a high reflective silver deposition as described in Example 13 (see FIG. 6). The conductivity the resulting deposits was not analyzed.

### EXAMPLE 15

Polyimide foil was used as the substrate. TRIS was the complexing agent and silver was used as the metal. The silver complex was formed as described in Example 11. The substrate was coated with 1 wt % TiO₂-solution in H₂0tEtOH (ratio of H₂0:EtOH→30:70 wt %) by flooding, and the resulting TiO₂-film was dried at ˜270° C. for 15 minutes. The silver complex was applied to the substrate and covered with 1 mm thick PMMA foil. A fine structured mask consisting of quartz glass was put on the laminated PMMA-foil. Afterwards the substrate was irradiated with UV-light as described in Example 11 for 2 minutes through the quartz glass mask and the PMMA foil. The mask and the PMMA foil were removed and the remaining silver complex was removed and the substrate dried as described in Example 11.

The resulting silver film conformed to the pattern in the quartz glass, as confirmed under light microscopy, forming various silver microstructures. The silver that was deposited on the substrate was highly reflective. The Furthermore the depositions were silver and high reflective. The conductivity of the deposited silver was not analyzed.

Another test showed that reflective depositions were already obtained after application of UV Light for only 45 seconds.

### EXAMPLE 16

PET foil was used for substrate TRIS was the complexing agent and silver was the metal. The substrate was coated with TiO₂ by flooding of 1 wt % TiO₂-solution in H₂0/EtOH→20:80 wt %, and was dried at 120° C. for 1 hour. Afterwards the TiO₂-layer was flushed with deionized water and dried. The silver complex was formed as described in Example 11. The silver complex was applied to the substrate and covered with 1 mm thick PMMA foil as described in Example 15. The fine structured quartz glass mask was put on the laminated PMMA-foil. The irradiation occurred with UV-light as described in Example 11 for 3 minutes. The mask was removed, the substrate washed and dried as described in Example 15.

The result (see FIG. 7) was similar to that described in Example 15.

### EXAMPLE 17

Polyimide and PET foil were used for substrates. TRIS was used as the complexing agent and silver as the metal. The initiator was TiO₂-particles that were modified with 1-Thioglycerol. A 1 wt % TiO₂-solution in H₂0/EtOH (ratio of H₂0:EtOH→20:80 wt %) and a 5 wt % 1-Thioglycerol-solution in EtOH were prepared. 0.3 g (5 wt %) 1-Thioglycerol-solution was added to 5.7 g (1 wt %) TiO₂-solution. The substrates were coated with this modified TiO₂-solution by flooding. The drying occurred at 270° C. for 15 minutes for the polyimide foil and at 120° C. for 1 hour for the PET foil. The silver complex was made as described in Example 11. The silver complex was applied to the substrates as follows: an elastic hand frame was laid on the coated foil and the silver complex was added to its internal volume. After that the substrates were irradiated with C light as described in Example 11 for 40 seconds. The resulting substrate was washed and dried as described in Example 11.

The polyimide substrate showed that the adhesion of the silver coating to the modified TiO₂ was similar to the adhesion of the silver coating to the unmodified TiO₂ used in other examples. However, the PET substrate showed better adhesion to the modified TiO2 than to the unmodified TiO₂ described in other examples.

### EXAMPLE 18

Polyimide foil was used for substrate. TRIS was used as the complexing agent and silver as the metal. The substrate was coated with TiO₂ by flooding of 1 wt % TiO₂-solution in H₂0/EtOH→→20:80 wt % and was dried at 120° C. for 1 hour. Afterwards the TiO₂-layer was flushed with deionized water and dried. The silver complex was formed as described in Example 11. The silver complex was applied by flooding. The irradiation occurred with a Argon ion laser (351 nm) with 10 mW and speed of 2 mm/s. The inspection under the microscope showed, that highly reflective lines were obtained where the laser was applied (see FIGS. 8a-d).

### EXAMPLE 19

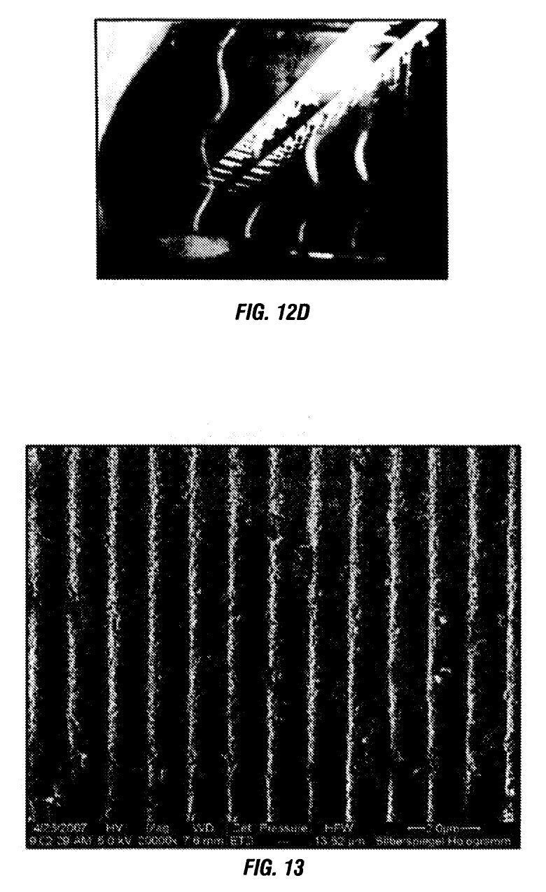

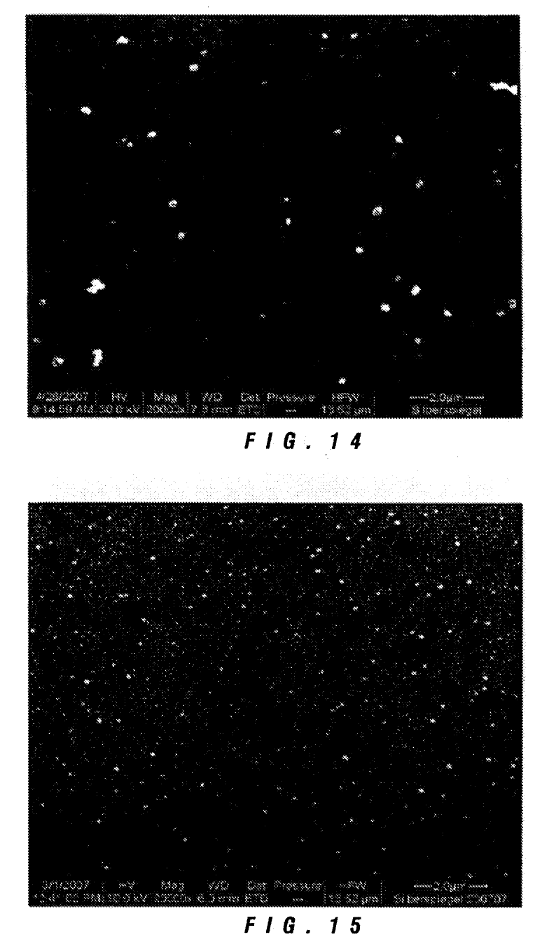

Polyimide foil and PET foil were used as substrates. A mixture of 3-Ap and 2-Ab were used as complexing agents and silver was used as the metal. Three solutions were prepared. The silver solution had 0.5 mmol of AgNO₃ in 1 g H₂0/EtOH 1:1. The complexing agent solution had 1 mmol 3-Ap and 2 mmol 2-Ab in 1 g H₂0/EtOH 1:1. The reducing agent solution had 1 M NaOH/EtOH 1:1. The silver solution and the complexing agent solution were mixed by stirring. Equal volumes of the silver/complexing agent solution and the reducing agent solution were mixed. The mixture was applied to the substrate via pipette. Three minutes after application, excess materials were removed by washing with deionized water. This resulted in a very nice silver mirror. The conductivity was not measured but based upon other characteristics of the produced film, it is likely as good or better than the others described and tested herein that are produced using titania and UV-light. FIGS. 11a-c are photographs of resulting coatings on holographic foils. FIG. 13 shows a scanning electron micrograph of a resulting silver coating on a holographic substrate. FIG. 14 shows a scanning electron micrograph of the resulting silver coating on a PET foil.

Further experimenting showed that the optimal ratio of complexing agent to silver was a molar ratio of 1.06 to 0.5 when using NaOH as the reducing agent.

### EXAMPLE 20

A 1% TiO₂ dispersion is applied to a PET or polyamide foil by a doctor blade technique resulting in a layer that is 15 micrometers thick (wet film). The coated substrate is dried at room temperature or at 110° C. for 15 minutes. TRIS is used as the complexing agent and silver as the metal. The silver solution is prepared similarly to that described in Example 11; a molar ratio of TRIS to AgNO₃ of 2.12 to 1 was used. The silver complex was applied to the dried substrate by the doctor blade method and the silver layer was 30 micrometers thick (wet film). The substrate having the silver complex applied was irradiated with 1000 W Xe-light for 30 to 60 seconds using a single light source at half power (v=6 m/min). Any remaining residues were washed off after irradiation using deionized water.

The resulting silver coating was highly reflective and conducting.

### EXAMPLE 21

PET foil having a holograph thereon was used for the substrate. TRIS was taken for complexing agent and silver as the metal. The silver complex was formed as described in Example 11. After coating with 1 wt % TiO₂-solution in H₂0/EtOH (ratio of H₂0:EtOH→30:70 wt %) by roller dip coating, the TiO2-film was dried at 120° C. for 1 hour in an oven. The TiO2-layer was flushed with deionized water and dried. The silver complex was applied as described in Example 11. UV light was applied as described in Example 11 for 1 minute. The remaining silver complex was washed off with deionized water and the substrate was dried by application of compressed air.

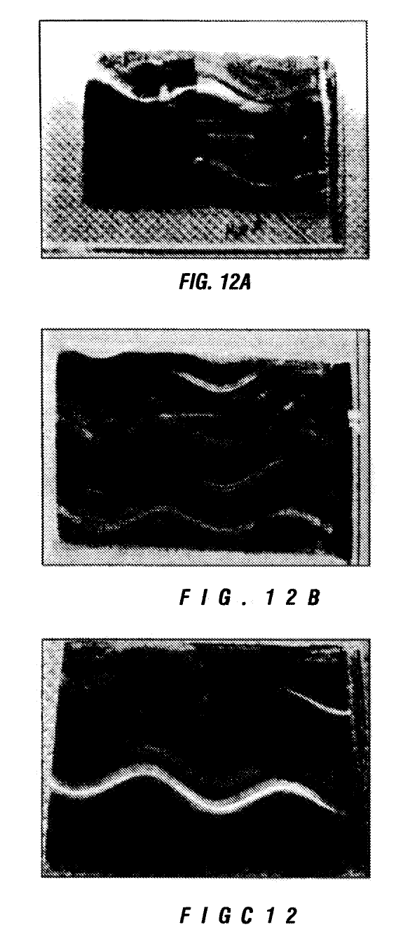

The result was a mirror-like high reflective film as described in Example 11 (see FIGS. 12a-d).

Thus, it is seen that methods and systems for applying a metal coating to a substrate are provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well

What is claimed is:

1. A method comprising the steps of:
providing a substrate coated with an initiator;
applying a metal to the substrate; and
reducing the metal, wherein the reducing results in a metal coating on the substrate that is conductive and highly reflective.

2. The method of claim 1 wherein the substrate comprises PET foil or polyamide foil.

3. The method of claim 1 wherein the substrate comprises surface reliefs.

4. The method of claim 1 wherein the step of applying a metal to the substrate occurs prior to the reducing the metal compound step.

5. The method of claim 4 wherein the step of reducing the metal comprises application of visible light, UV light or laser light to the metal compound.

6. The method of claim 1 wherein the step of applying a metal comprises application of a metal complex.

7. The method of claim 6 wherein the metal complex comprises a metal and a complexing agent.

8. The method of claim 7 wherein the metal is silver and the complexing agent is TRIS, 3-Ap, 2-Ab or a mixture of 3-Ap and 2-Ab.

9. The method of claim 1 wherein the initiator comprises TiO₂.

10. The method of claim 1 wherein the metal is selected from the group consisting of: copper, gold, nickel, zinc, aluminum, titanium, chromium, manganese, tungsten, platinum, palladium, steel, brass, bronze and duralumin.

11. A method comprising the steps of:
providing a substrate coated with TiO₂;
applying a metal complex to the substrate; and
applying visible, laser, or UV light to the substrate, wherein the applying visible, laser, or UV light results in a metal coating on the substrate that is highly reflective.

12. The method of claim 11 wherein the substrate comprises PET foil or polyamide foil.

13. The method of claim 11 wherein the substrate comprises surface reliefs.

14. The method of claim 11 wherein the metal coating on the substrate is conductive.

15. The method of claim 11 the metal complex comprises a metal and a complexing agent.

16. The method of claim 15 wherein the metal is silver and the complexing agent comprises TRIS, 3-Ap, 2-Ab or a mixture of 3-Ap and 2-Ab.

17. The method of claim 11 wherein the TiO₂ comprises an electron transferring surfactant.

18. The method of claim 17 wherein the electron transferring surfactant is modified anatase nanoparticles.

19. The method of claim 16 wherein the metal complex is made by a process comprising the steps of:
adding AgNO₃ to a solution of H₂0/EtOH to form a metal solution; and
adding the metal solution to a solution of H₂0/EtOH and TRIS.

20. The method of claim 16 wherein the metal complex is selected from the group consisting of: copper, gold, nickel, zinc, aluminum, titanium, chromium, manganese, tungsten, platinum, palladium, steel, brass, bronze and duralumin.

21. A method comprising the steps of:
providing a substrate coated with a TiO2 solution;
applying a metal complex to the substrate; and
selectively applying visible, laser, or UV light to the substrate, wherein the selectively applying visible, laser, or UV light results in a metal coating on the substrate that is highly reflective only on the selected portions of the substrate.

22. The method of claim 21 wherein the selectively applying step comprises placement of an element that has portions that permit substantial passage of visible, laser, or UV light, and portions that do not permit substantial passage of visible, laser, or UV light.

23. A system comprising:
a substrate coating applicator configured to apply a coating to a substrate;
a heating element configured to apply heat to the substrate;
a metal complex applicator configured to apply a metal complex to the substrate; and
a light source configured to provide light comprising one or more of UV light and laser light.

24. The system of claim 23 wherein the coating comprises TiO₂.

25. The system of claim 23 wherein the metal complex comprises silver and one or more of TRIS, 3-Ap and 2-Ab.

26. The system of claim 23 wherein the light source is configured to provide light sufficient to form a metal coating on the substrate.

27. The system of claim 26 wherein the metal coating is highly reflective and conductive.

28. The method of claim 16 wherein the metal complex is selected from the group consisting of: copper, gold, nickel, zinc, aluminum, titanium, chromium, manganese, tungsten, platinum, palladium, steel brass, bronze and duralumin.
